(19) United States
(12) Patent Application Publication
(10) Pub. No.: US 2022/0116173 A1
(43) Pub. Date: Apr. 14, 2022

(54) REPORTING DOWNLINK REFERENCE SIGNALS ASSOCIATED WITH MULTIPLE ANTENNA PANELS

(71) Applicant: QUALCOMM Incorporated, San Diego, CA (US)

(72) Inventors: Yan ZHOU, San Diego, CA (US); Tianyang BAI, Somerville, NJ (US); Tao LUO, San Diego, CA (US)

(21) Appl. No.: 17/450,166

(22) Filed: Oct. 6, 2021

Related U.S. Application Data
(60) Provisional application No. 63/089,393, filed on Oct. 8, 2020.
(60) Provisional application No. 63/089,400, filed on Oct. 8, 2020.

(51) Int. Cl. H04L 5/00; H04W 24/10

(52) U.S. Cl. CPC H04L 5/0048; H04W 24/10

(57) ABSTRACT

A base station may transmit one or more reference signals to a user equipment (UE) to measure. However, the base station is typically limited to configuring one downlink reference signal per antenna panel of the UE. This can reduce network efficiency because the base station has to switch downlink reference signals in order to switch antenna panels. Techniques and apparatuses described herein allow a UE to transmit a report that includes a plurality of measurements of a downlink reference signal corresponding to a plurality of antenna panels and/or to transmit a report that includes one or more measurements of a plurality of downlink reference signals from an antenna panel. The base station may therefore map a downlink reference signal to a plurality of antenna panels of the UE. Accordingly, the base station is able to switch antenna panels without switching downlink reference signals.

### CROSS-REFERENCE TO RELATED APPLICATION

This patent application claims priority to U.S. Provisional Patent Application No. 63/089,393, filed on Oct. 8, 2020, entitled “REPORTING DOWNLINK REFERENCE SIGNALS ASSOCIATED WITH MULTIPLE ANTENNA PANELS,” and assigned to the assignee hereof. The disclosure of the prior application is considered part of and is incorporated by reference in this patent application.

### FIELD OF THE DISCLOSURE

Aspects of the present disclosure generally relate to wireless communication and to techniques and apparatuses for reporting downlink reference signals associated with multiple antenna panels.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. 5G, which may be referred to as New Radio (NR), is a set of enhancements to the LTE mobile standard promulgated by the 3GPP. 5G is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in 4G, 5G, and other radio access technologies remain useful.

### SUMMARY

In some situations, a user equipment (UE) may include multiple antenna panels, where each panel includes a plurality of antenna elements (e.g., cross-polarized elements and/or other similar antenna elements). An antenna panel may include a physical grouping of antenna elements (e.g., the elements are embedded in a same substrate and/or sharing one or more hardware components, such as a modulator, a demodulator, and/or a processor) and/or a virtual grouping of antenna elements (e.g., the elements are grouped by the UE based at least in part on one or more properties of the elements). Generally, a base station may transmit one or more reference signals to the UE to measure. For example, the base station may configure a channel state information (CSI) report using a CSI-ReportConfig message (e.g., as defined in 3GPP specifications and/or other standards) and/or another similar message. However, the base station is typically limited to configuring one downlink reference signal per antenna panel of the UE. This reduces network efficiency when an antenna panel is blocked or otherwise experiencing interference because the base station may have to switch to a different downlink reference signal in order to switch antenna panels. Accordingly, when that different downlink reference signal is weaker or otherwise suboptimal, the UE and the base station experience reduced reliability and quality of communications as well as increased network overhead (e.g., from additional retransmissions used on account of the lower reliability and quality). The increased network overhead further causes the base station and the UE to consume additional processing resources and power.

Some techniques and apparatuses described herein allow a UE (e.g., UE 120 of FIG. 1 and/or apparatus 1000 of FIG. 10) to transmit a report that includes a plurality of measurements of a downlink reference signal corresponding to a plurality of antenna panels. Additionally, or alternatively, some techniques and apparatuses described herein allow the UE 120 to transmit a report that includes one or more measurements of a plurality of downlink reference signals from an antenna panel. A base station (e.g., base station 110 of FIG. 1 and/or apparatus 1200 of FIG. 12) may map a downlink reference signal to a plurality of antenna panels associated with the UE 120. Accordingly, when an antenna panel is blocked or otherwise experiencing interference, the base station 110 is able to switch antenna panels without switching downlink reference signals. Thus, the UE 120 and the base station 110 experience increased reliability and quality of communications as well as decreased network overhead. The reduced network overhead further causes the base station and the UE to conserve processing resources and power.

Some aspects described herein relate to a method of wireless communication performed by a UE. The method may include measuring, using a first plurality of antenna panels associated with the UE, a first reference signal from a base station. The method may further include transmitting, to the base station, a first report based at least in part on measuring the first reference signal, wherein the first report includes corresponding identifiers for each antenna from the first plurality of antenna panels.

Some aspects described herein relate to a method of wireless communication performed by a base station. The method may include transmitting, to a UE, a first reference signal. The method may further include receiving, from the UE, a first report based at least in part on one or more measurements of the first reference signal, wherein the first report includes corresponding identifiers for each antenna from a first plurality of antenna panels associated with the UE.

Some aspects described herein relate to a method of wireless communication performed by a UE. The method may include measuring, using a first antenna panel associated with the UE, a first plurality of reference signals from a base station. The method may further include transmitting, to the base station, a first report based at least in part on measuring the first plurality of reference signals, wherein the first report is associated with a corresponding identifier for the first antenna panel.

Some aspects described herein relate to a method of wireless communication performed by a base station. The method may include transmitting, to a UE, a first plurality of reference signals. The method may further include receiving, from the UE, a first report based at least in part on measurements of the first plurality of reference signals, wherein the first report is associated with a corresponding identifier for a first antenna panel associated with the UE.

Some aspects described herein relate to an apparatus for wireless communication at a UE. The apparatus may include a memory and one or more processors coupled to the memory. The one or more processors may be configured to measure, using a first plurality of antenna panels associated with the UE, a first reference signal from a base station. The one or more processors may be further configured to transmit, to the base station, a first report based at least in part on measuring the first reference signal, wherein the first report includes corresponding identifiers for each antenna from the first plurality of antenna panels.

Some aspects described herein relate to an apparatus for wireless communication at a base station. The apparatus may include a memory and one or more processors coupled to the memory. The one or more processors may be configured to transmit, to a UE, a first reference signal. The one or more processors may be further configured to receive, from the UE, a first report based at least in part on one or more measurements of the first reference signal, wherein the first report includes corresponding identifiers for each antenna from a first plurality of antenna panels associated with the UE.

Some aspects described herein relate to an apparatus for wireless communication at a UE. The apparatus may include a memory and one or more processors coupled to the memory. The one or more processors may be configured to measure, using a first antenna panel associated with the UE, a first plurality of reference signals from a base station. The one or more processors may be further configured to transmit, to the base station, a first report based at least in part on measuring the first plurality of reference signals, wherein the first report is associated with a corresponding identifier for the first antenna panel.

Some aspects described herein relate to an apparatus for wireless communication at a base station. The base station may include a memory and one or more processors coupled to the memory. The one or more processors may be configured to transmit, to a UE, a first plurality of reference signals. The one or more processors may be further configured to receive, from the UE, a first report based at least in part on measurements of the first plurality of reference signals, wherein the first report is associated with a corresponding identifier for a first antenna panel associated with the UE.

Some aspects described herein relate to a non-transitory computer-readable medium that stores a set of instructions for wireless communication by a UE. The set of instructions, when executed by one or more processors of the UE, may cause the UE to measure, using a first plurality of antenna panels associated with the UE, a first reference signal from a base station. The set of instructions, when executed by one or more processors of the UE, may further cause the UE to transmit, to the base station, a first report based at least in part on measuring the first reference signal, wherein the first report includes corresponding identifiers for each antenna from the first plurality of antenna panels.

Some aspects described herein relate to a non-transitory computer-readable medium that stores a set of instructions for wireless communication by a base station. The set of instructions, when executed by one or more processors of the base station, may cause the base station to transmit, to a UE, a first reference signal. The set of instructions, when executed by one or more processors of the base station, may further cause the base station to receive, from the UE, a first report based at least in part on one or more measurements of the first reference signal, wherein the first report includes corresponding identifiers for each antenna from a first plurality of antenna panels associated with the UE.

Some aspects described herein relate to a non-transitory computer-readable medium that stores a set of instructions for wireless communication by a UE. The set of instructions, when executed by one or more processors of the UE, may cause the UE to measure, using a first antenna panel associated with the UE, a first plurality of reference signals from a base station. The set of instructions, when executed by one or more processors of the UE, may further cause the UE to transmit, to the base station, a first report based at least in part on measuring the first plurality of reference signals, wherein the first report is associated with a corresponding identifier for the first antenna panel.

Some aspects described herein relate to a non-transitory computer-readable medium that stores a set of instructions for wireless communication by a base station. The set of instructions, when executed by one or more processors of the base station, may cause the base station to transmit, to a UE, a first plurality of reference signals. The set of instructions, when executed by one or more processors of the base station, may further cause the base station to receive, from the UE, a first report based at least in part on measurements of the first plurality of reference signals, wherein the first report is associated with a corresponding identifier for a first antenna panel associated with the UE.

Some aspects described herein relate to an apparatus for wireless communication. The apparatus may include means for measuring, using a first plurality of antenna panels associated with the apparatus, a first reference signal from a base station. The apparatus may further include means for transmitting, to the base station, a first report based at least in part on measuring the first reference signal, wherein the first report includes corresponding identifiers for each antenna from the first plurality of antenna panels.

Some aspects described herein relate to an apparatus for wireless communication. The apparatus may include means for transmitting, to a UE, a first reference signal. The apparatus may further include means for receiving, from the UE, a first report based at least in part on one or more measurements of the first reference signal, wherein the first report includes corresponding identifiers for each antenna from a first plurality of antenna panels associated with the UE.

Some aspects described herein relate to an apparatus for wireless communication. The apparatus may include means for measuring, using a first antenna panel associated with the apparatus, a first plurality of reference signals from a base station. The apparatus may further include means for transmitting, to the base station, a first report based at least in part on measuring the first plurality of reference signals, wherein the first report is associated with a corresponding identifier for the first antenna panel.

Some aspects described herein relate to an apparatus for wireless communication. The apparatus may include means for transmitting, to a UE, a first plurality of reference signals. The apparatus may further include means for receiving, from the UE, a first report based at least in part on measurements of the first plurality of reference signals, wherein the first report is associated with a corresponding identifier for a first antenna panel associated with the UE.

Aspects generally include a method, apparatus, system, computer program product, non-transitory computer-readable medium, user equipment, base station, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is diagram illustrating an example of a wireless network.

FIG. 2 is a diagram illustrating an example of a base station in communication with a user equipment (UE) in a wireless network.

FIG. 3 is a diagram illustrating an example of antenna ports.

FIG. 4 is a diagram illustrating an example associated with reporting downlink reference signals associated with multiple antenna panels.

FIG. 5 is a diagram illustrating an example associated with reporting multiple downlink reference signals associated with an antenna panel.

FIGS. 6, 7, 8, and 9 are flowcharts of example methods of wireless communication.

FIG. 10 is a diagram of an example apparatus for wireless communication.

FIG. 11 is a diagram illustrating an example of a hardware implementation for an apparatus employing a processing system.

FIG. 12 is a diagram of another example apparatus for wireless communication.

FIG. 13 is a diagram illustrating another example of a hardware implementation for an apparatus employing a processing system.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

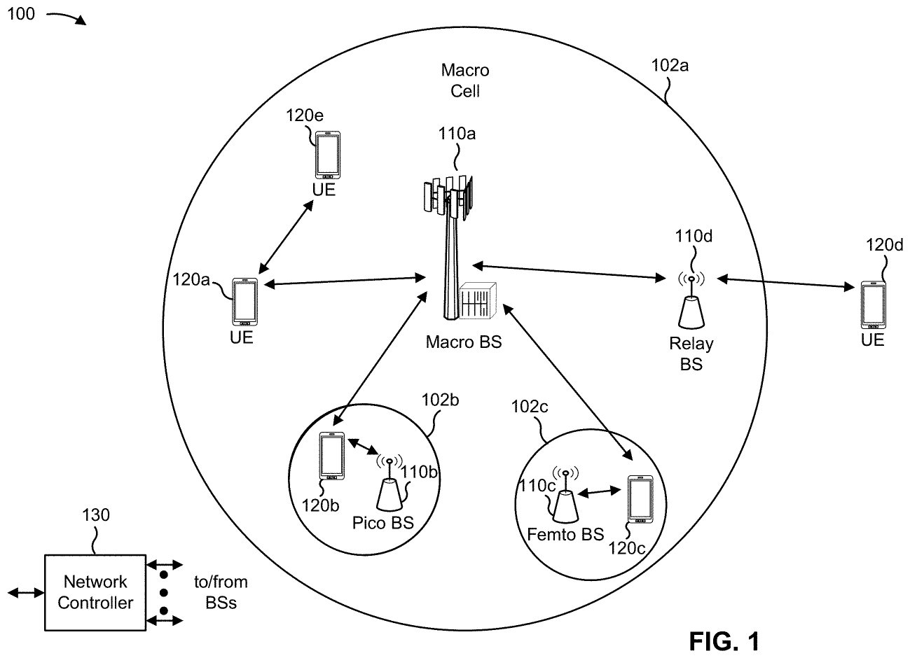

FIG. 1 is a diagram illustrating a wireless network 100 in which aspects of the present disclosure may be practiced. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As indicated above, FIG. 1 is provided as an example. Other examples may differ from what is described with regard to FIG. 1.

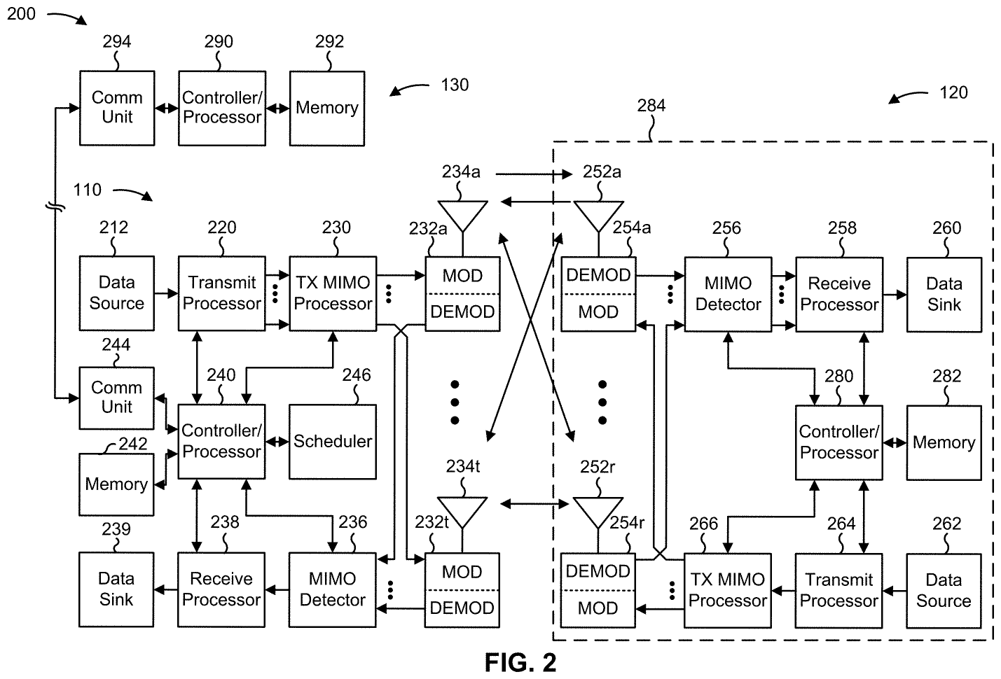

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

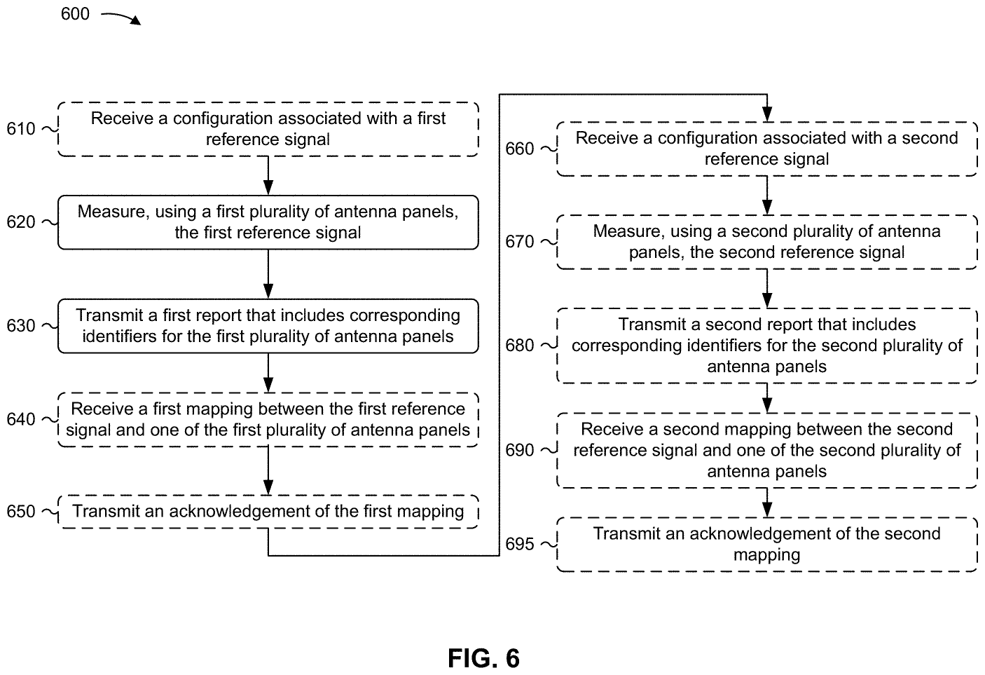

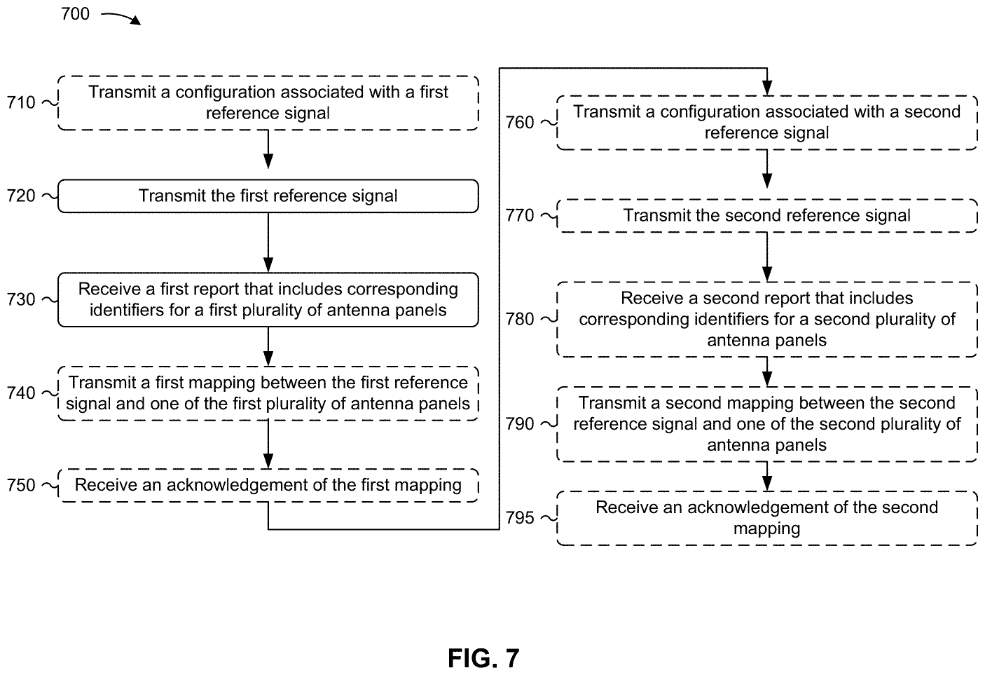

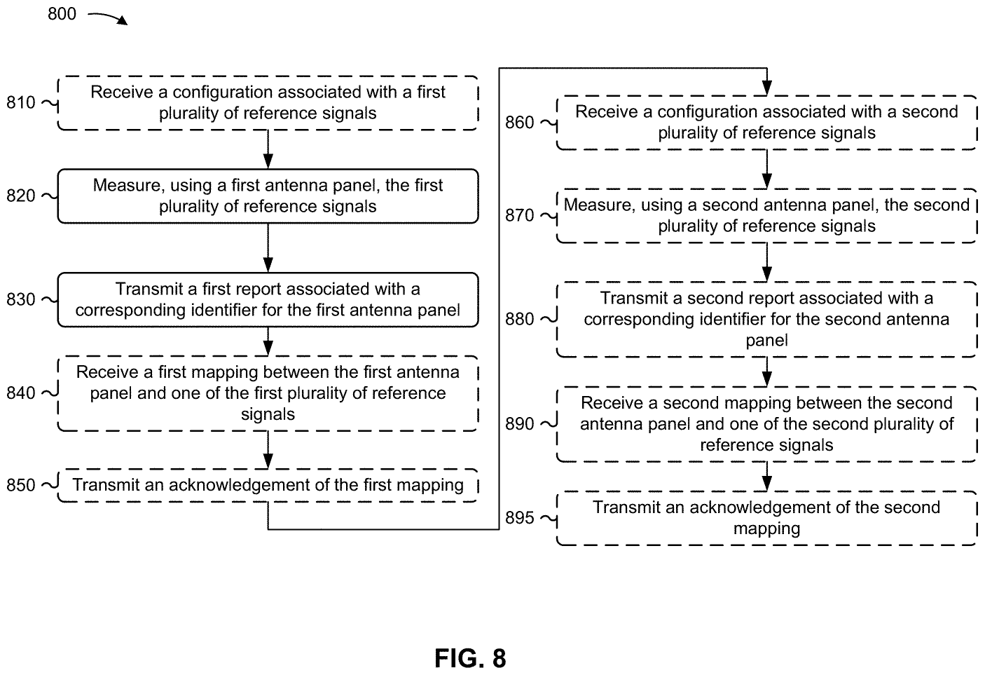

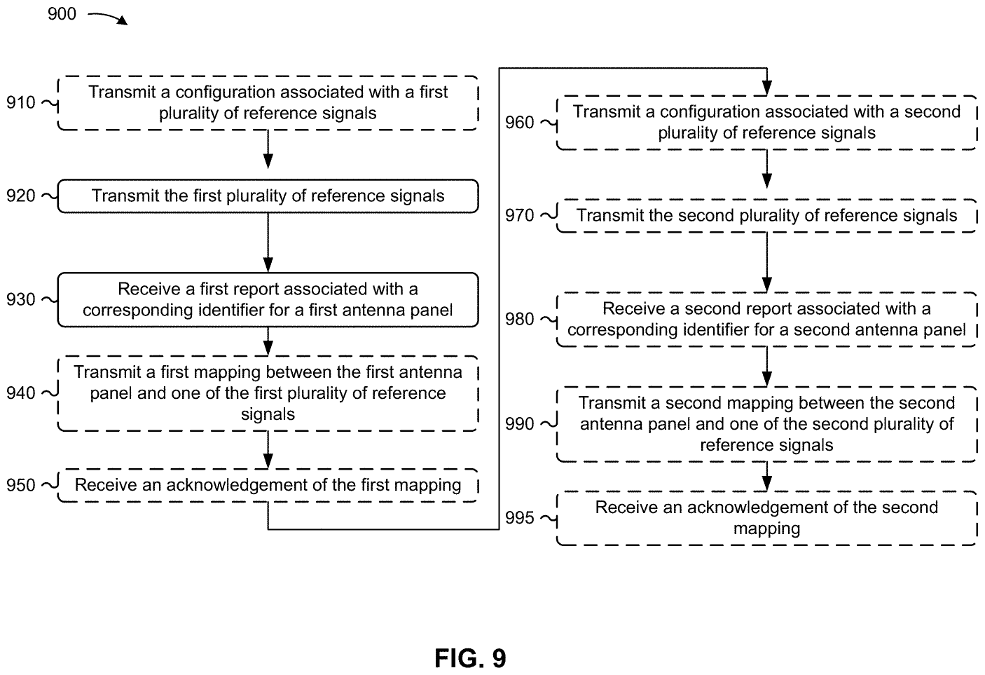

The controller/processor 240 of the base station 110, the controller/processor 280 of the UE 120, and/or any other component(s) of FIG. 2 may perform one or more techniques associated with reporting downlink reference signals associated with multiple antenna panels, as described in more detail elsewhere herein. For example, the controller/processor 240 of the base station 110, the controller/processor 280 of the UE 120, and/or any other component(s) of FIG. 2 may perform or direct operations of, for example, method 600 of FIG. 6, method 700 of FIG. 7, method 800 of FIG. 8, method 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, method 600 of FIG. 6, method 700 of FIG. 7, method 800 of FIG. 8, method 900 of FIG. 9, and/or other processes as described herein. In some examples, executing instructions may include running the instructions, converting the instructions, compiling the instructions, and/or interpreting the instructions, among other examples.

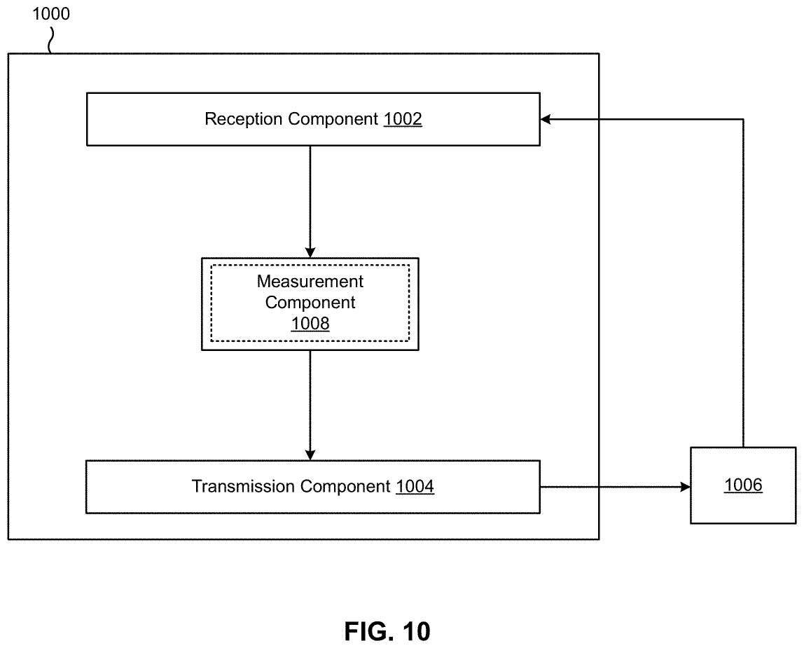

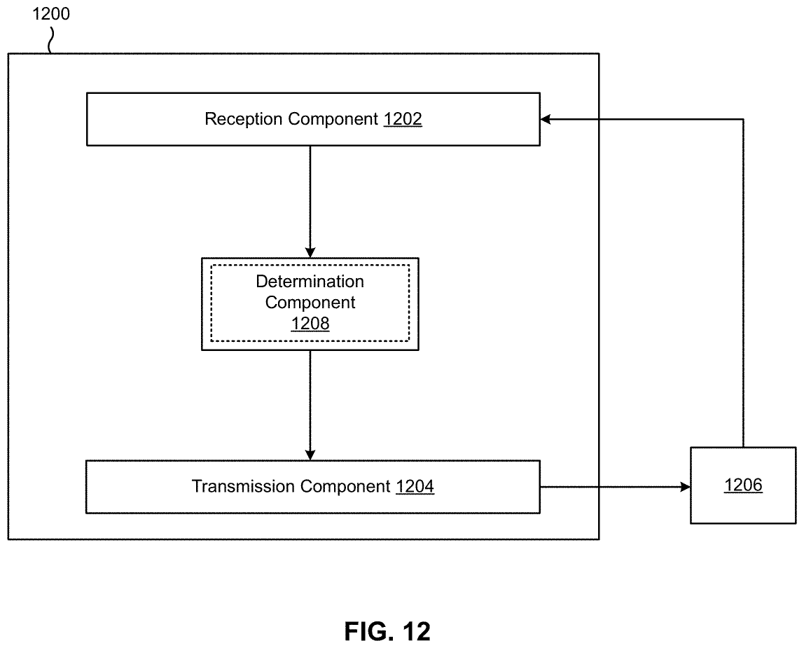

In some aspects, a UE (e.g., apparatus 1000 of FIG. 10 and/or the UE 120) may include means for measuring, using a first plurality of antenna panels associated with the UE, a first reference signal from a base station (e.g., apparatus 1200 of FIG. 12 and/or the base station 110); and/or means for transmitting, to the base station, a first report based at least in part on measuring the first reference signal, wherein the first report includes corresponding identifiers for each antenna from the first plurality of antenna panels. Additionally, or alternatively, the UE may include means for measuring, using a first antenna panel associated with the UE, a first plurality of reference signals from the base station; and/or means for transmitting, to the base station, a first report based at least in part on measuring the first plurality of reference signals, wherein the first report is associated with a corresponding identifier for the first antenna panel. The means for the UE to perform operations described herein may include, for example, one or more of antenna 252, modem 254, MIMO detector 256, receive processor 258, transmit processor 264, TX MIMO processor 266, controller/processor 280, or memory 282.

In some aspects, a base station (e.g., apparatus 1200 of FIG. 12 and/or the base station 110) may include means for transmitting, to a UE (e.g., apparatus 1000 of FIG. 10 and/or the UE 120), a first reference signal; and/or means for receiving, from the UE, a first report based at least in part on one or more measurements of the first reference signal, wherein the first report includes corresponding identifiers for each antenna from a first plurality of antenna panels associated with the UE. Additionally, or alternatively, the base station may include means for transmitting, to the UE, a first plurality of reference signals; and/or means for receiving, from the UE, a first report based at least in part on measurements of the first plurality of reference signals, wherein the first report is associated with a corresponding identifier for a first antenna panel associated with the UE. The means for the base station to perform operations described herein may include, for example, one or more of transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

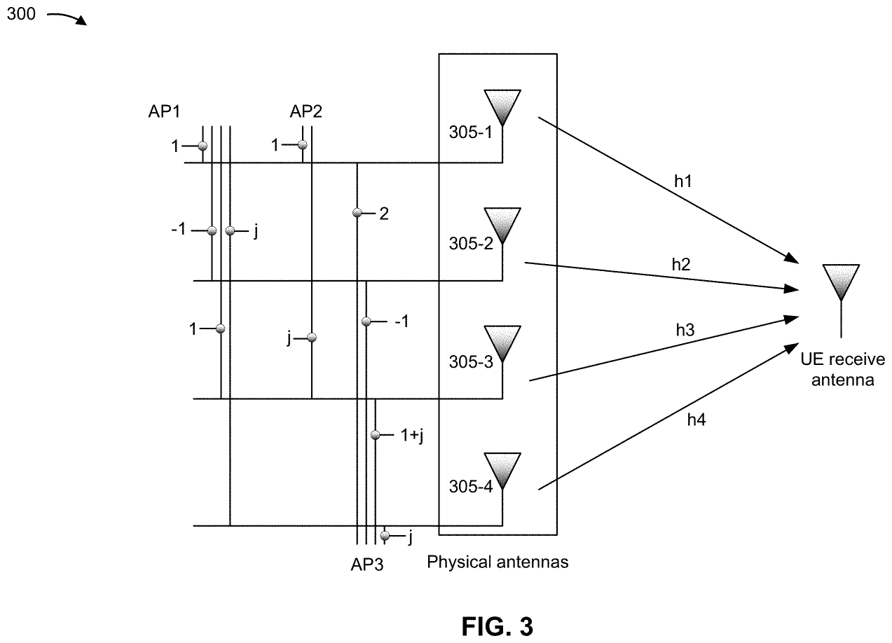

FIG. 3 is a diagram illustrating an example 300 of antenna ports, in accordance with the present disclosure. As shown in FIG. 3, a first physical antenna 305-1 may transmit information via a first channel h1, a second physical antenna 305-2 may transmit information via a second channel h2, a third physical antenna 305-3 may transmit information via a third channel h3, and a fourth physical antenna 305-4 may transmit information via a fourth channel h4. Such information may be conveyed via a logical antenna port, which may represent some combination of the physical antennas and/or channels. In some cases, a UE 120 may not have knowledge of the channels associated with the physical antennas, and may only operate based on knowledge of the channels associated with antenna ports, as defined below.

An antenna port may be defined such that a channel, over which a symbol on the antenna port is conveyed, can be inferred from a channel over which another symbol on the same antenna port is conveyed. In example 300, a channel associated with antenna port 1 (AP1) is represented as h1−h2+h3+j*h4, where channel coefficients (e.g., 1, −1, 1, and j, in this case) represent weighting factors (e.g., indicating phase and/or gain) applied to each channel. Such weighting factors may be applied to the channels to improve signal power and/or signal quality at one or more receivers. Applying such weighting factors to channel transmissions may be referred to as precoding, and a precoder may refer to a specific set of weighting factors applied to a set of channels.

Similarly, a channel associated with antenna port 2 (AP2) is represented as h1+j*h3, and a channel associated with antenna port 3 (AP3) is represented as 2*h1−h2+(1+j)*h3+j*h4. In this case, antenna port 3 can be represented as the sum of antenna port 1 and antenna port 2 (e.g., AP3=AP1+AP2) because the sum of the expression representing antenna port 1 (h1−h2+h3+j*h4) and the expression representing antenna port 2 (h1+j*h3) equals the expression representing antenna port 3 (2*h1−h2+(1+j)*h3+j*h4). It can also be said that antenna port 3 is related to antenna ports 1 and 2 [AP1,AP2] via the precoder [1,1] because 1 times the expression representing antenna port 1 plus 1 times the expression representing antenna port 2 equals the expression representing antenna port 3.

In some situations, a UE may include multiple antenna panels, where each panel includes a plurality of antenna elements. For example, the UE may include three panels, where each panel has N antenna elements (e.g., cross-polarized elements and/or other similar antenna elements). An antenna panel may include a physical grouping of antenna elements (e.g., the elements are embedded in a same substrate and/or sharing one or more hardware components, such as a modulator, a demodulator, and/or a processor) and/or a virtual grouping of antenna elements (e.g., the elements are grouped by the UE based at least in part on one or more properties of the elements). In some situations, the UE may assign antenna ports (e.g., as described in connection with FIG. 3) across antenna panels such that antenna ports that cannot simultaneously transmit and/or simultaneously receive are included on a same panel.

Generally, a base station may transmit one or more reference signals to the UE to measure. For example, the base station may configure a CSI report using a CSI-ReportConfig message (e.g., as defined in 3GPP specifications and/or other standards) and/or another similar message. However, the base station is typically limited to configuring one downlink reference signal per antenna panel of the UE. This reduces network efficiency when an antenna panel is blocked or otherwise experiencing interference because the base station may have to switch to a different downlink reference signal in order to switch antenna panels. Accordingly, when that different downlink reference signal is weaker or otherwise suboptimal, the UE and the base station experience reduced reliability and quality of communications as well as increased network overhead (e.g., from additional retransmissions used on account of the lower reliability and quality). The increased network overhead further causes the base station and the UE to consume additional processing resources and power.

Some techniques and apparatuses described herein allow a UE (e.g., UE 120) to transmit a report that includes a plurality of measurements of a downlink reference signal corresponding to a plurality of antenna panels. Additionally, or alternatively, some techniques and apparatuses described herein allow the UE 120 to transmit a report that includes one or more measurements of a plurality of downlink reference signals from an antenna panel. A base station (e.g., base station 110) may map a downlink reference signal to a plurality of antenna panels associated with the UE 120. Accordingly, when an antenna panel is blocked or otherwise experiencing interference, the base station 110 is able to switch antenna panels without switching downlink reference signals. Thus, the UE 120 and the base station 110 experience increased reliability and quality of communications as well as decreased network overhead. The reduced network overhead further causes the base station and the UE to conserve processing resources and power.

As indicated above, FIG. 3 is provided merely as an example. Other examples may differ from what is described with regard to FIG. 3.

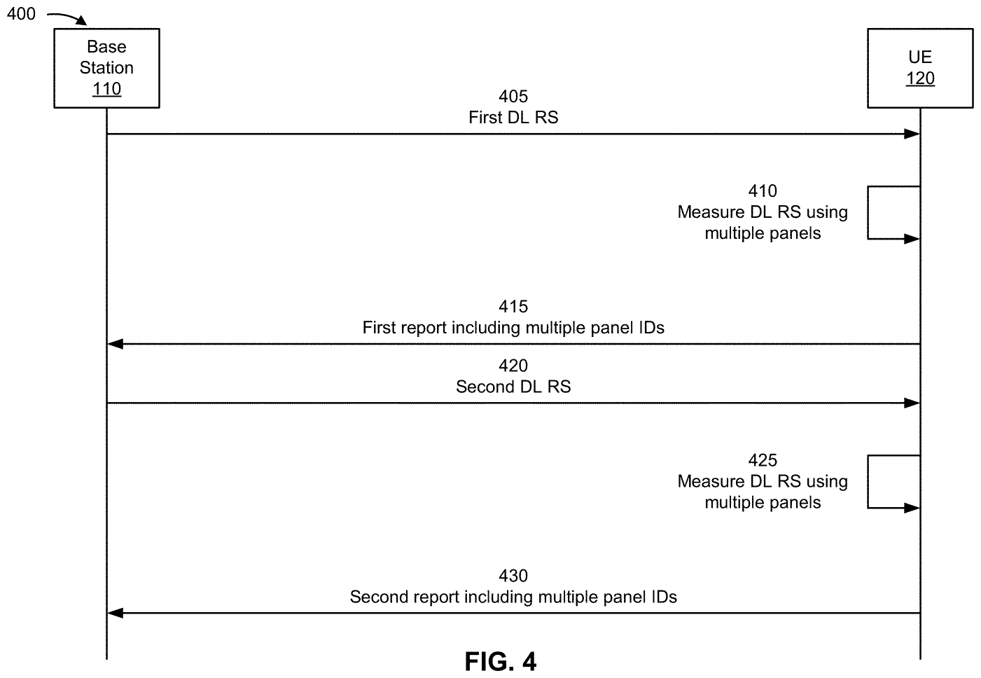

FIG. 4 is a diagram illustrating an example 400 associated with reporting downlink reference signals associated with multiple antenna panels, in accordance with the present disclosure. As shown in FIG. 4, example 400 includes communication between a base station 110 and a UE 120. In some aspects, the base station 110 and the UE 120 may be included in a wireless network, such as wireless network 100. The base station 110 and the UE 120 may communicate on a wireless access link, which may include an uplink and a downlink.

At 405, in some aspects, the base station 110 may transmit, to the UE 120, a first reference signal. For example, the first reference signal may include a synchronization signal block (SSB), a tracking reference signal (TRS), a CSI reference signal (CSI-RS), and/or another reference signal.

In some aspects, the base station 110 may transmit, and the UE 120 may receive a configuration for the first reference signal. For example, the base station 110 may transmit a CSI-ReportConfig message (e.g., as defined in 3GPP specifications and/or other standards). Although the description herein focuses on a CSI-ReportConfig message, the description similarly applies to other configuration messages. In some aspects, the base station 110 may select the first reference signal from a set of reference signals configured in a CSI-ResourceConfig data structure (e.g., as defined in 3GPP specifications and/or other standards). Although the description herein focuses on a CSI-ResourceConfig data structure, the description similarly applies to other data structures. Accordingly, the CSI-ReportConfig message may be associated with a corresponding CSI-ResourceConfig data structure.

In some aspects, the configuration may indicate a quantity of antenna panels in a first plurality of antenna panels associated with the UE 120. For example, the base station 110 may request measurements of the first reference signal from two antenna panels, three antenna panels, and so on. In some aspects, the indication may be based at least in part on a capability associated with the UE 120. For example, the base station 110 may determine that the UE 120 has three antenna panels that can receive on the downlink and, accordingly, request measurements of the first reference signal from no more than three antenna panels. In some aspects, the UE 120 may transmit, and the base station 110 may receive, an indication of the capability associated with the UE 120. For example, the UE 120 may transmit, and the base station 110 may receive, a UECapabilityInformation message (e.g., as defined in 3GPP specifications and/or other standards). Although the description herein focuses on a UECapabilityInformation message, the description similarly applies to other capability messages.

As an alternative, the configuration may indicate a maximum quantity of antenna panels such that the quantity of the first plurality of antenna panels associated with the UE 120 is less than or equal to the maximum quantity. For example, the base station 110 may request measurements of the first reference signal from no more than two antenna panels, no more than three antenna panels, and so on. In some aspects, the indication may be based at least in part on a capability associated with the UE 120. For example, the base station 110 may determine that the UE 120 has a total of four antenna panels and, accordingly, request measurements of the first reference signal from no more than four antenna panels. In some aspects, the UE 120 may transmit, and the base station 110 may receive, an indication of the capability associated with the UE 120. For example, the UE 120 may transmit, and the base station 110 may receive, a UECapabilityInformation message (e.g., as defined in 3GPP specifications and/or other standards). Additionally, or alternatively, the maximum quantity may be programmed (and/or otherwise preconfigured) into the UE 120 and/or the base station 110 according to 3GPP specifications and/or other standards.

At 410, in some aspects, the UE 120 may measure, using the first plurality of antenna panels associated with the UE 120, the first reference signal from the base station 110. In some aspects, measuring the first reference signal may comprise determining an RSRP, a signal-to-interference-and-noise ratio (SINR), a CQI, a rank indicator (RI), a precoding matrix indicator (PMI), an interference estimate, a pathloss estimate (e.g., calculated as a subtraction of the RSRP from a transmit power associated with the first reference signal), a power headroom for uplink, a power backoff for uplink (e.g., calculated as a subtraction of a maximum allowed transmit power associated with the UE 120 from a maximum transmit power associated with the UE 120), an estimated RSRP for uplink, or a combination thereof.

At 415, in some aspects, the UE 120 may transmit, and the base station 110 may receive, a first report, based at least in part on one or more measurements of the first reference signal, that includes corresponding identifiers for each antenna from the first plurality of antenna panels. For example, the first report may include a CSI report and/or another report based at least in part on one or more measurements of the first reference signal. In some aspects, the first report may be included in uplink control information (UCI) or a control element (e.g., a medium access control (MAC) control element (MAC-CE) and/or another similar control element).

In some aspects, the corresponding identifiers may be selected from a space of downlink identifiers. As used herein, “space of downlink identifiers” refers to a set of identifiers that are associated with antenna panels used for downlink communications. The set may be associated with downlink communications by preconfiguration (e.g., according to 3GPP specifications and/or another standard) or may be calculated according to a formula that is associated with downlink communications. For example, one or more portions of the corresponding identifiers (e.g., most significant bits (MSBs), least significant bits (LSBs), and/or other portions) may indicate that the first plurality of antenna panels are configured to receive on the downlink. In some aspects, the first report may further include one or more identifiers, corresponding to one or more of the first plurality of antenna panels, selected from a space of uplink identifiers. As used herein, “space of uplink identifiers” refers to a set of identifiers that are associated with antenna panels used for uplink communications. The set may be associated with uplink communications by preconfiguration (e.g., according to 3GPP specifications and/or another standard) or may be calculated according to a formula that is associated with uplink communications. For example, the UE 120 may include two identifiers (e.g., one from the space of downlink identifiers and another from the space of uplink identifiers) for one or more antenna panels, in the first plurality of antenna panels, that are configured to receive on the downlink as well as transmit on the uplink. In some aspects, the base station 110 may transmit, and the UE 120 may receive, an instruction to include the one or more identifiers selected from the space of uplink identifiers. The instruction may be included in the configuration for the first reference signal (e.g., as described above) or in a separate message. As an alternative, the UE 120 may determine to include the one or more identifiers selected from the space of uplink identifiers. Accordingly, the first report may further include bits indicating that the one or more identifiers, selected from the space of uplink identifiers, are included in the first report. For example, the UE 120 may include, with each of the corresponding identifiers, a corresponding flag (e.g., a single bit) indicating whether an identifier, from the space of uplink identifiers, is also included.

As an alternative, the corresponding identifiers may be selected from a space of joint downlink-uplink identifiers. As used herein, “space of joint downlink-uplink identifiers” refers to a set of identifiers that are associated with antenna panels regardless of whether the antenna panels are associated with downlink communications and/or uplink communications. For example, the identifiers may be calculated according to a formula that is the same whether an antenna panel is associated with downlink communications, uplink communications, or both. Accordingly, the corresponding identifiers may not indicate whether the first plurality of antenna panels are configured to receive on the downlink or are configured to receive on the downlink as well as transmit on the uplink.

In some aspects, the first report may further include bits indicating the quantity of the first plurality of antenna panels associated with the UE 120. For example, the UE 120 may include, in the first report, an integer indicating the quantity of the first plurality of antenna panels. Additionally, or alternatively, the UE 120 may include, in a portion of the report, a flag (e.g., a single bit) indicating whether the report includes further measurements or ends. For example, when the first plurality of antenna panels include two panels, a first portion of the report may include one or more measurements from one of the first plurality of antenna panels as well as the flag indicating the presence of additional measurements, and a second portion of the report may include one or more measurements from the other of the first plurality of antenna panels as well as the flag indicating the end of the report.

In some aspects, the first report may include a plurality of absolute measurement values. For example, the first report may include, for each of the first plurality of antenna panels, a corresponding absolute measurement (e.g., an absolute RSRP, an absolute SINR, and/or another absolute measurement) of the first reference signal.

As an alternative, the first report may include at least one absolute measurement value and at least one relative measurement value. For example, the first report may include at least one absolute measurement (e.g., an absolute RSRP, an absolute SINR, and/or another absolute measurement), of the first reference signal, taken by at least one of the first plurality of antenna panels and at least one differential, with respect to the at least one absolute measurement, for one or more other measurements, of the first reference signal, taken by one or more others of the first plurality of antenna panels.

As an alternative, the first report may include a plurality of relative measurement values. For example, the first report may include a plurality of differentials, with respect to at least one absolute measurement (e.g., an absolute RSRP, an absolute SINR, and/or another absolute measurement) of a different reference signal, for measurements, of the first reference signal, taken by the first plurality of antenna panels.

In some aspects, the first report may include a predetermined value when a measurement associated with at least one antenna panel of the first plurality of antenna panels does not satisfy a measurement threshold. For example, the first report may include a not-a-number (NaN) codepoint and/or another codepoint indicating that the measurement did not satisfy the measurement threshold. In some aspects, the base station 110 may transmit, and the UE 120 may receive, an indication of the predetermined value. The predetermined value may be indicated in the configuration for the first reference signal (e.g., as described above) or in a separate message. Additionally, or alternatively, the predetermined value may be programmed (and/or otherwise preconfigured) into the UE 120 and/or the base station 110 according to 3GPP specifications and/or other standards.

As an alternative, the base station 110 may transmit, and the UE 120 may receive, an indication of a measurement threshold such that the first report does not include measurements that do not satisfy the measurement threshold. For example, the first report may include a null value and/or otherwise exclude measurements that did not satisfy the measurement threshold. The measurement threshold may be indicated in the configuration for the first reference signal (e.g., as described above) or in a separate message. Additionally, or alternatively, the measurement threshold may be programmed (and/or otherwise preconfigured) into the UE 120 and/or the base station 110 according to 3GPP specifications and/or other standards. In some aspects, the measurement threshold may include an absolute value. For example, the measurement threshold may be −100 dbM RSRP and/or another similar absolute value. As an alternative, the measurement threshold may include a relative value. For example, the measurement threshold may be 50% of the RSRP of a highest measurement of the first reference signal, 50% of the RSRP of a highest measurement of a different reference signal, and/or another similar relative value.

At 420, in some aspects, the base station 110 may transmit, to the UE 120, a second reference signal. For example, the second reference signal may include an SSB, a TRS, a CSI-RS, and/or another reference signal.

In some aspects, the base station 110 may transmit, and the UE 120 may receive a configuration for the second reference signal. For example, the base station 110 may transmit a CSI-ReportConfig message (e.g., as defined in 3GPP specifications and/or other standards). In some aspects, the base station 110 may select the second reference signal from a set of reference signals configured in a CSI-ResourceConfig data structure (e.g., as defined in 3GPP specifications and/or other standards). Accordingly, the CSI-ReportConfig message may be associated with a corresponding CSI-ResourceConfig data structure.

In some aspects, the configuration for the second reference signal may include some or all of the indications as described above at 405 with respect to the configuration for the first reference signal. The configuration for the second reference signal may be included with the configuration for the first reference signal (e.g., as described above) or in a separate message.

At 425, in some aspects, the UE 120 may measure, using a second plurality of antenna panels associated with the UE 120, the second reference signal from the base station 110. For example, the UE 120 may measure the second reference signal similarly to measuring the first reference signal as described above at 410.

At 430, in some aspects, the UE 120 may transmit, and the base station 110 may receive, a second report, based at least in part on one or more measurements of the second reference signal, that includes corresponding identifiers for each antenna from the second plurality of antenna panels. For example, the second report may include some or all of the information as described above at 415 with respect to the first report.

In some aspects, the base station 110 may further transmit, and the UE 120 may receive, based at least in part on the first report, an indication of a first mapping between the first reference signal and one of the first plurality of antenna panels. In some aspects, the first mapping may be indicated in a radio resource control (RRC) message, a control element (e.g., a MAC-CE and/or another similar control element), and/or downlink control information (DCI). In one example, the first reference signal may include a CSI-RS, a sounding reference signal (SRS), and/or a physical uplink control channel (PUCCH) resource, and the first mapping may be indicated in an RRC message. In another example, the first reference signal may include a physical downlink control channel (PDCCH) resource, and the first mapping may be indicated in a MAC-CE that activates a transmission configuration indicator (TCI) state for the PDCCH. In yet another example, the first reference signal may include a physical downlink shared channel (PDSCH) resource and/or a physical uplink shared channel (PUSCH) resource, and the first mapping may be indicated in DCI.

In some aspects, the first mapping may apply a period of time after receiving the indication of the first mapping. For example, the UE 120 may apply the first mapping (e.g., by activating the one of the first plurality of antenna panels) after the period of time. In some aspects, the period of time may be based at least in part on a configuration message from the base station 110 (e.g., the configuration for the first reference signal) and/or an amount of time programmed (and/or otherwise preconfigured) into the UE 120 according to 3GPP specifications and/or other standards. Additionally, or alternatively, the UE 120 may transmit, and the base station 110 may receive, an acknowledgement of the indication of the first mapping such that the first mapping applies a period of time after the UE 120 transmits and/or the base station 110 receives the acknowledgement. For example, the base station 110 may apply the first mapping (e.g., by transmitting based at least in part on the first reference signal) after the period of time. In some aspects, the period of time may be based at least in part on a configuration message from the base station 110 (e.g., the configuration for the first reference signal) and/or an amount of time programmed (and/or otherwise preconfigured) into the base station 110 according to 3GPP specifications and/or other standards.

Additionally, or alternatively, the base station 110 may similarly transmit, and the UE 120 may receive, based at least in part on the second report, an indication of a second mapping between the second reference signal and one of the second plurality of antenna panels. In some aspects, the second mapping may apply a period of time after receiving the indication of the second mapping, as described above with respect to the first mapping. Additionally, or alternatively, the UE 120 may transmit, and the base station 110 may receive, an acknowledgement of the indication of the second mapping such that the second mapping applies a period of time after the UE 120 transmits and/or the base station 110 receives the acknowledgement, as described above with respect to the first mapping.

By using techniques as described in connection with FIG. 4, the base station 110 may map a downlink reference signal to a plurality of antenna panels associated with the UE 120. Accordingly, the base station 110 is able to switch antenna panels without switching downlink reference signals. Thus, the UE 120 and the base station 110 experience increased reliability and quality of communications as well as decreased network overhead.

As indicated above, FIG. 4 is provided as an example. Other examples may differ from what is described with respect to FIG. 4.

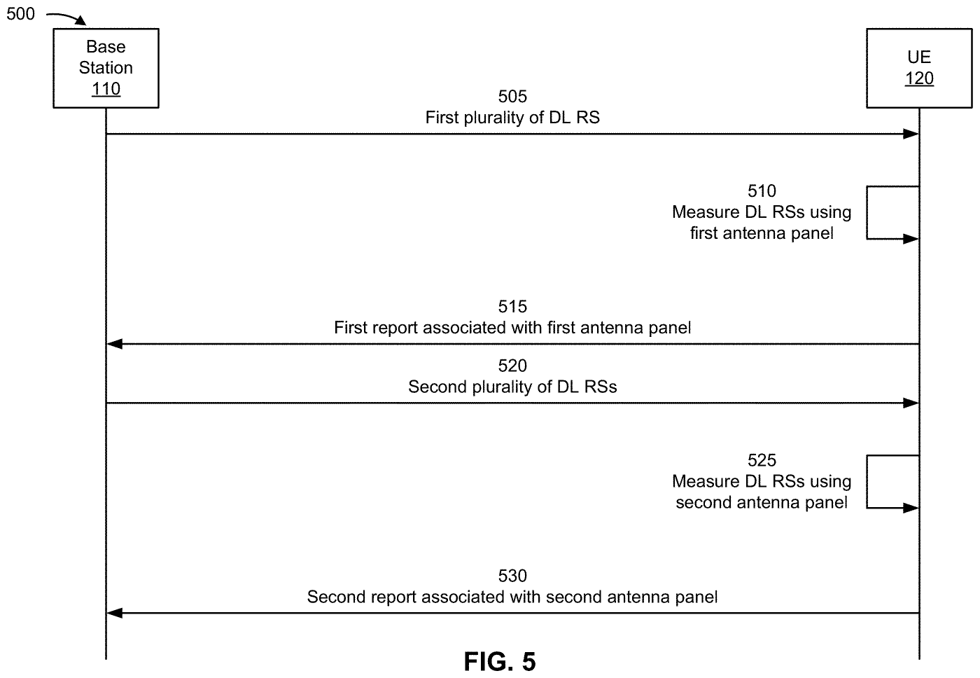

FIG. 5 is a diagram illustrating an example 500 associated with reporting downlink reference signals associated with multiple antenna panels, in accordance with the present disclosure. As shown in FIG. 5, example 500 includes communication between a base station 110 and a UE 120. In some aspects, the base station 110 and the UE 120 may be included in a wireless network, such as wireless network 100. The base station 110 and the UE 120 may communicate on a wireless access link, which may include an uplink and a downlink.

At 505, in some aspects, the base station 110 may transmit, to the UE 120, a first plurality of reference signals. For example, the first plurality of reference signals may include one or more SSBs, one or more TRSs, one or more CSI-RSs, and/or one or more other reference signals.

In some aspects, the base station 110 may transmit, and the UE 120 may receive a configuration for the first plurality of reference signals. For example, the base station 110 may transmit a CSI-ReportConfig message (e.g., as defined in 3GPP specifications and/or other standards). In some aspects, the base station 110 may select the first plurality of reference signals from a set of reference signals configured in a CSI-ResourceConfig data structure (e.g., as defined in 3GPP specifications and/or other standards). Accordingly, the CSI-ReportConfig message may be associated with a corresponding CSI-ResourceConfig data structure.

In some aspects, the configuration may indicate a quantity of the first plurality of reference signals. For example, the quantity may be less than or equal to a total quantity of reference signal resources configured by the base station 110 (e.g., in a CSI-ResourceConfig data structure as described above). In some aspects, the indication may be based at least in part on a capability associated with the UE 120. For example, the base station 110 may determine that the UE 120 has three antenna panels that can receive on the downlink and, accordingly, request measurements of no more than three reference signals. In some aspects, the UE 120 may transmit, and the base station 110 may receive, an indication of the capability associated with the UE 120. For example, the UE 120 may transmit, and the base station 110 may receive, a UECapabilityInformation message (e.g., as defined in 3GPP specifications and/or other standards).

As an alternative, the configuration may indicate a maximum quantity of reference signals such that the quantity of the first plurality of reference signals is less than or equal to the maximum quantity. For example, the maximum quantity may be less than or equal to a total quantity of reference signal resources configured by the base station 110 (e.g., in a CSI-ResourceConfig data structure as described above). In some aspects, the indication may be based at least in part on a capability associated with the UE 120. For example, the base station 110 may determine that the UE 120 has a total of four antenna panels and, accordingly, request measurements of no more than four reference signals. In some aspects, the UE 120 may transmit, and the base station 110 may receive, an indication of the capability associated with the UE 120. For example, the UE 120 may transmit, and the base station 110 may receive, a UECapabilityInformation message (e.g., as defined in 3GPP specifications and/or other standards). Additionally, or alternatively, the maximum quantity may be programmed (and/or otherwise preconfigured) into the UE 120 and/or the base station 110 according to 3GPP specifications and/or other standards.

In some aspects, the configuration may indicate a first antenna panel associated with the UE 120. For example, the configuration may include an identifier (e.g., from a space of downlink identifiers or space of joint downlink-uplink identifiers) associated with the first antenna panel. In some aspects, the indication may be based at least in part on a capability associated with the UE 120. For example, the UE 120 may transmit, and the base station 110 may receive, an indication including one or more identifiers associated with antenna panels of the UE 120. In some aspects, the UE 120 may transmit, and the base station 110 may receive, a UECapabilityInformation message (e.g., as defined in 3GPP specifications and/or other standards).

At 510, in some aspects, the UE 120 may measure, using the first antenna panel associated with the UE 120, the first plurality of reference signals from the base station 110. In some aspects, measuring the first plurality of reference signals may comprise determining at least one RSRP, at least one SINR, at least one CQI, at least one RI, at least one PMI, at least one interference estimate, at least one pathloss estimate, at least one power headroom for uplink, at least one power backoff for uplink, at least one estimated RSRP for uplink, or a combination thereof.

At 515, in some aspects, the UE 120 may transmit, and the base station 110 may receive, a first report, based at least in part on measurements of the first plurality of reference signals, that is associated with a corresponding identifier for the first antenna panel. In some aspects, the first report may be included in UCI or a control element (e.g., a MAC-CE and/or another similar control element).

In some aspects, the first report may not explicitly include the corresponding identifier for the first antenna panel. For example, the base station 110 may include the corresponding identifier in the configuration for the first plurality of reference signals (e.g., as described above) such that the base station 110 and the UE 120 may associate the first report with the first antenna panel even when the first report does not include the corresponding identifier.

As an alternative, the first report may further include the corresponding identifier for the first antenna panel. In some aspects, the corresponding identifier may be selected from a space of downlink identifiers. For example, one or more portions of the corresponding identifiers (e.g., MSBs, LSBs, and/or other portions) may indicate that the first antenna panel is configured to receive on the downlink. In some aspects, the first report may further include an identifier, corresponding to the first antenna panel, selected from a space of uplink identifiers. For example, the UE 120 may include two identifiers (e.g., one from the space of downlink identifiers and another from the space of uplink identifiers) for the first antenna panel when the first antenna panel is configured to receive on the downlink as well as transmit on the uplink. In some aspects, the base station 110 may transmit, and the UE 120 may receive, an instruction to include the identifier selected from the space of uplink identifiers. The instruction may be included in the configuration for the first plurality of reference signals (e.g., as described above) or in a separate message. As an alternative, the UE 120 may determine to include the identifier selected from the space of uplink identifiers. Accordingly, the first report may further include bits indicating that the identifier, selected from the space of uplink identifiers, is included in the first report. For example, the UE 120 may include a corresponding flag (e.g., a single bit) indicating whether the identifier, from the space of uplink identifiers, is also included.

As an alternative, the corresponding identifier may be selected from a space of joint downlink-uplink identifiers. For example, the corresponding identifier may not indicate whether the first antenna panel is configured to receive on the downlink or is configured to receive on the downlink as well as transmit on the uplink.

In some aspects, the first report may include a plurality of absolute measurement values. For example, the first report may include, for each of the first plurality of reference signals, a corresponding absolute measurement (e.g., an absolute RSRP, an absolute SINR, and/or another absolute measurement) taken by the first antenna panel.

As an alternative, the first report may include at least one absolute measurement value and at least one relative measurement value. For example, the first report may include at least one absolute measurement (e.g., an absolute RSRP, an absolute SINR, and/or another absolute measurement), of at least one of the first plurality of reference signals, from the first antenna panel and at least one differential, with respect to the at least one absolute measurement, for one or more other measurements, of one or more others of the first plurality of reference signals, taken by the first antenna panel.

As an alternative, the first report may include a plurality of relative measurement values. For example, the first report may include a plurality of differentials, with respect to at least one absolute measurement (e.g., an absolute RSRP, an absolute SINR, and/or another absolute measurement) taken by a different antenna panel, for measurements, of the first plurality of reference signals, taken by the first antenna panel.

At 520, in some aspects, the base station 110 may transmit, to the UE 120, a second plurality of reference signals. For example, the second plurality of reference signals may include one or more SSBs, one or more TRSs, one or more CSI-RSs, and/or one or more other reference signals.

In some aspects, the base station 110 may transmit, and the UE 120 may receive a configuration for the second plurality of reference signals. For example, the base station 110 may transmit a CSI-ReportConfig message (e.g., as defined in 3GPP specifications and/or other standards). In some aspects, the base station 110 may select the second plurality of reference signals from a set of reference signals configured in a CSI-ResourceConfig data structure (e.g., as defined in 3GPP specifications and/or other standards). Accordingly, the CSI-ReportConfig message may be associated with a corresponding CSI-ResourceConfig data structure.

In some aspects, the configuration for the second plurality of reference signals may include some or all of the indications as described above at 505 with respect to the configuration for the first plurality of reference signals. The configuration for the second plurality of reference signals may be included with the configuration for the first plurality of reference signals (e.g., as described above) or in a separate message.

At 525, in some aspects, the UE 120 may measure, using a second antenna panel associated with the UE 120, the second plurality of reference signals from the base station 110. For example, the UE 120 may measure the second plurality of reference signals similarly to measuring the first plurality of reference signals as described above at 510.

At 530, in some aspects, the UE 120 may transmit, and the base station 110 may receive, a second report, based at least in part on measurements of the second plurality of reference signals, that is associated with a corresponding identifier for the second antenna panel. For example, the second report may include some or all of the information as described above at 515 with respect to the first report.

In some aspects, the base station 110 may further transmit, and the UE 120 may receive, based at least in part on the first report, an indication of a first mapping between one of the first plurality of reference signals and the first antenna panel. In some aspects, the first mapping may be indicated in an RRC message, a control element (e.g., a MAC-CE and/or another similar control element), and/or DCI. In one example, the first plurality of reference signals may include a CSI-RS, an SRS, and/or a PUCCH resource, and the first mapping may be indicated in an RRC message. In another example, the first plurality of reference signals may include a PDCCH resource, and the first mapping may be indicated in a MAC-CE that activates a TCI state for the PDCCH. In yet another example, the first plurality of reference signals may include a PDSCH resource and/or a PUSCH resource, and the first mapping may be indicated in DCI.

In some aspects, the first mapping may apply a period of time after receiving the indication of the first mapping. For example, the UE 120 may apply the first mapping (e.g., by activating the first antenna panel) after the period of time. In some aspects, the period of time may be based at least in part on a configuration message from the base station 110 (e.g., the configuration for the first reference signal) and/or an amount of time programmed (and/or otherwise preconfigured) into the UE 120 according to 3GPP specifications and/or other standards. Additionally, or alternatively, the UE 120 may transmit, and the base station 110 may receive, an acknowledgement of the indication of the first mapping such that the first mapping applies a period of time after the UE 120 transmits and/or the base station 110 receives the acknowledgement. For example, the base station 110 may apply the first mapping (e.g., by transmitting based at least in part on the one of the first plurality of reference signals) after the period of time. In some aspects, the period of time may be based at least in part on a configuration message from the base station 110 (e.g., the configuration for the first reference signal) and/or an amount of time programmed (and/or otherwise preconfigured) into the base station 110 according to 3GPP specifications and/or other standards

Additionally, or alternatively, the base station 110 may similarly transmit, and the UE 120 may receive, based at least in part on the second report, an indication of a second mapping between one of the plurality of second reference signals and the second antenna panel. In some aspects, the second mapping may apply a period of time after receiving the indication of the second mapping, as described above with respect to the first mapping. Additionally, or alternatively, the UE 120 may transmit, and the base station 110 may receive, an acknowledgement of the indication of the second mapping such that the second mapping applies a period of time after the UE 120 transmits and/or the base station 110 receives the acknowledgement, as described above with respect to the first mapping.

By using techniques as described in connection with FIG. 5, the base station 110 may map a downlink reference signal to a plurality of antenna panels associated with the UE 120. Accordingly, the base station 110 is able to switch antenna panels without switching downlink reference signals. Thus, the UE 120 and the base station 110 experience increased reliability and quality of communications as well as decreased network overhead.

In some aspects, example 500 may be combined with example 400. For example, the UE 120 may transmit a first report that is based at least in part on measurements of a first plurality of reference signals (e.g., as described above at 515) and that includes corresponding identifiers for each antenna from a first plurality of antenna panels (e.g., as described at 415 of FIG. 4). Similarly, the UE 120 may transmit a second report that is based at least in part on measurements of a second plurality of reference signals (e.g., as described above at 530) and that includes corresponding identifiers for each antenna from a second plurality of antenna panels (e.g., as described at 430 of FIG. 4).

As indicated above, FIG. 5 is provided as an example. Other examples may differ from what is described with respect to FIG. 5.

FIG. 6 is a flowchart of an example method 600 of wireless communication. The method 600 may be performed by, for example, a UE (e.g., UE 120 of FIG. 1 and/or apparatus 1000 of FIG. 10).

At 610, in some aspects, the UE may receive, from a base station (e.g., base station 110 of FIG. 1 and/or apparatus 1200 of FIG. 12), a configuration associated with a first reference signal. For example, the UE (e.g., using reception component 1002, depicted in FIG. 10) may receive the configuration, as described above in connection with, for example, FIG. 4 and at 405. In some aspects, the configuration includes an instruction to include one or more identifiers selected from the space of uplink identifiers. Additionally, or alternatively, the configuration includes an indication of a quantity of antenna panels in the first plurality of antenna panels associated with the UE. The indication may be based at least in part on a capability associated with the UE. Additionally, or alternatively, the configuration includes an indication of a maximum quantity of antenna panels, such that a quantity of antenna panels in the first plurality of antenna panels associated with the UE is less than or equal to the maximum quantity. The indication may be based at least in part on a capability associated with the UE. Additionally, or alternatively, the configuration includes an indication of a measurement threshold such that all measurements in the first report (e.g., as described below at 630) satisfy the measurement threshold. The measurement threshold may include an absolute value and/or a relative value.

At 620, the UE may measure, using a first plurality of antenna panels associated with the UE, a first reference signal from the base station. For example, the UE (e.g., using measurement component 1008, depicted in FIG. 10) may measure the first reference signal, as described above in connection with, for example, FIG. 4 and at 410. In some aspects, measuring the first reference signal comprises determining at least one of an RSRP, an SINR, a CQI, an RI, a PMI, an interference estimate, a pathloss estimate, a power headroom for uplink, a power backoff for uplink, an estimated RSRP for uplink, or a combination thereof.

At 630, the UE may transmit, to the base station, a first report, based at least in part on measuring the first reference signal, that includes corresponding identifiers for each antenna from the first plurality of antenna panels. For example, the UE (e.g., using transmission component 1004, depicted in FIG. 10) may transmit the first report, as described above in connection with, for example, FIG. 4 and at 415. In some aspects, the first report is included in UCI or a control element. In some aspects, the corresponding identifiers are selected from a space of downlink identifiers. Additionally, in some aspects, the first report further includes one or more identifiers, corresponding to one or more of the first plurality of antenna panels, selected from a space of uplink identifiers. In such aspects, the first report may further include bits indicating that the one or more identifiers, selected from the space of uplink identifiers, are included in the first report. As an alternative, the corresponding identifiers are selected from a space of joint downlink-uplink identifiers.

In some aspects, the first report includes a predetermined value when a measurement associated with at least one antenna panel of the first plurality of antenna panels does not satisfy a measurement threshold. Additionally, or alternatively, the first report includes bits indicating the quantity of the first plurality of antenna panels associated with the UE.

In some aspects, the first report includes a plurality of absolute measurement values. As an alternative, the first report includes at least one absolute measurement value and at least one relative measurement value. As an alternative, the first report includes a plurality of relative measurement values.

At 640, the UE may receive, from the base station and based at least in part on the first report, an indication of a first mapping between the first reference signal and one of the first plurality of antenna panels. For example, the UE (e.g., using reception component 1002) may receive the first mapping, as described above in connection with, for example, FIG. 4. In some aspects, the first mapping is included in an RRC message, a control element, or DCI. In some aspects, the first mapping is applied a period of time after receiving the indication of the first mapping.

At 650, the UE may transmit, to the base station, an acknowledgement based at least in part on receiving the indication of the first mapping. For example, the UE (e.g., using transmission component 1004) may transmit the acknowledgement, as described above in connection with, for example, FIG. 4. In some aspects, the first mapping is applied a period of time after transmitting the acknowledgement.

At 660, in some aspects, the UE may receive, from the base station, a configuration associated with a second reference signal. For example, the UE (e.g., using reception component 1002) may receive the configuration, as described above in connection with, for example, FIG. 4 and at 420. In some aspects, the configuration may include some or all of the indications as described above at 610 with respect to the configuration associated with the first reference signal. The configuration associated with the second reference signal may be included with the configuration associated with the first reference signal or in a separate message.

At 670, the UE may measure, using a second plurality of antenna panels associated with the UE, the second reference signal from the base station. For example, the UE (e.g., using measurement component 1008) may measure the second reference signal, as described above in connection with, for example, FIG. 4 and at 425. In some aspects, measuring the second reference signal comprises determining at least one of an RSRP, an SINR, a CQI, an RI, a PMI, an interference estimate, a pathloss estimate, a power headroom for uplink, a power backoff for uplink, an estimated RSRP for uplink, or a combination thereof.

At 680, the UE may transmit, to the base station, a second report, based at least in part on measuring the second reference signal, that includes corresponding identifiers for each antenna from the second plurality of antenna panels. For example, the UE (e.g., using transmission component 1004) may transmit the second report, as described above in connection with, for example, FIG. 4 and at 430. In some aspects, the second report is included in UCI or a control element. In some aspects, the second report may include some or all of the information as described above at 630 with respect to the first report.

At 690, the UE may receive, from the base station and based at least in part on the second report, an indication of a second mapping between the second reference signal and one of the second plurality of antenna panels. For example, the UE (e.g., using reception component 1002) may receive the second mapping, as described above in connection with, for example, FIG. 4. In some aspects, the second mapping is included in an RRC message, a control element, or DCI. In some aspects, the second mapping is applied a period of time after receiving the indication of the second mapping.

At 695, the UE may transmit, to the base station, an acknowledgement based at least in part on receiving the indication of the second mapping. For example, the UE (e.g., using transmission component 1004) may transmit the acknowledgement, as described above in connection with, for example, FIG. 4. In some aspects, the second mapping is applied a period of time after transmitting the acknowledgement.

Although FIG. 6 shows example blocks of method 600, in some aspects, method 600 may include additional blocks, fewer blocks, different blocks, or differently arranged blocks than those depicted in FIG. 6. Additionally, or alternatively, two or more of the blocks of method 600 may be performed in parallel.

FIG. 7 is a flowchart of an example method 700 of wireless communication. The method 700 may be performed by, for example, a base station (e.g., base station 110 of FIG. 1 and/or apparatus 1200 of FIG. 12).

At 710, in some aspects, the base station may transmit, to a UE (e.g., UE 120 of FIG. 1 and/or apparatus 1000 of FIG. 10), a configuration associated with a first reference signal. For example, the base station (e.g., using transmission component 1204, depicted in FIG. 12) may transmit the configuration, as described above in connection with, for example, FIG. 4 and at 405. In some aspects, the configuration includes an instruction to include one or more identifiers selected from the space of uplink identifiers. Additionally, or alternatively, the configuration includes an indication of a quantity of antenna panels in the first plurality of antenna panels associated with the UE. The indication may be based at least in part on a capability associated with the UE. Additionally, or alternatively, the configuration includes an indication of a maximum quantity of antenna panels, such that a quantity of antenna panels in the first plurality of antenna panels associated with the UE is less than or equal to the maximum quantity. The indication may be based at least in part on a capability associated with the UE. Additionally, or alternatively, the configuration includes an indication of a measurement threshold such that all measurements in the first report (e.g., as described below at 730) satisfy the measurement threshold. The measurement threshold may include an absolute value and/or a relative value.

At 720, the base station may transmit, to the UE, the first reference signal. For example, the base station (e.g., using transmission component 1204) may transmit the first reference signal, as described above in connection with, for example, FIG. 4 and at 410. In some aspects, the first reference signal may include an SSB, a TRS, a CSI-RS, and/or another reference signal.

At 730, the base station may receive, from the UE, a first report, based at least in part on one or more measurements of the first reference signal, that includes corresponding identifiers for each antenna from a first plurality of antenna panels associated with the UE. For example, the base station (e.g., using reception component 1202, depicted in FIG. 12) may receive the first report, as described above in connection with, for example, FIG. 4 and at 415. In some aspects, the one or more measurements of the first reference signal include at least one of an RSRP, an SINR, a CQI, an RI, a PMI, an interference estimate, a pathloss estimate, a power headroom for uplink, a power backoff for uplink, an estimated RSRP for uplink, or a combination thereof.

In some aspects, the first report is included in UCI or a control element. In some aspects, the corresponding identifiers are selected from a space of downlink identifiers. Additionally, in some aspects, the first report further includes one or more identifiers, corresponding to one or more of the first plurality of antenna panels, selected from a space of uplink identifiers. In such aspects, the first report may further include bits indicating that the one or more identifiers, selected from the space of uplink identifiers, are included in the first report. As an alternative, the corresponding identifiers are selected from a space of joint downlink-uplink identifiers.

In some aspects, the first report includes a predetermined value when a measurement associated with at least one antenna panel of the first plurality of antenna panels does not satisfy a measurement threshold. Additionally, or alternatively, the first report includes bits indicating the quantity of the first plurality of antenna panels associated with the UE.

In some aspects, the first report includes a plurality of absolute measurement values. As an alternative, the first report includes at least one absolute measurement value and at least one relative measurement value. As an alternative, the first report includes a plurality of relative measurement values.

At 740, the base station may transmit, to the UE and based at least in part on the first report, an indication of a first mapping between the first reference signal and one of the first plurality of antenna panels. For example, the base station (e.g., using transmission component 1204) may transmit the first mapping, as described above in connection with, for example, FIG. 4. In some aspects, the first mapping is included in an RRC message, a control element, or DCI. In some aspects, the first mapping is applied a period of time after receiving the indication of the first mapping.

At 750, the base station may receive, from the UE, an acknowledgement based at least in part on receiving the indication of the first mapping. For example, the base station (e.g., using reception component 1202) may receive the acknowledgement, as described above in connection with, for example, FIG. 4. In some aspects, the first mapping is applied a period of time after transmitting the acknowledgement.

At 760, in some aspects, the base station may transmit, to the UE, a configuration associated with a second reference signal. For example, the base station (e.g., using transmission component 1204) may transmit the configuration, as described above in connection with, for example, FIG. 4 and at 420. In some aspects, the configuration may include some or all of the indications as described above at 710 with respect to the configuration associated with the first reference signal. The configuration associated with the second reference signal may be included with the configuration associated with the first reference signal or in a separate message.

At 770, the base station may transmit, to the UE, the second reference signal. For example, the base station (e.g., using transmission component 1204) may transmit the second reference signal, as described above in connection with, for example, FIG. 4 and at 425. In some aspects, the second reference signal may include an SSB, a TRS, a CSI-RS, and/or another reference signal.

At 780, the base station may receive, from the UE, a second report, based at least in part on measuring the second reference signal, that includes corresponding identifiers for each antenna from the second plurality of antenna panels. For example, the base station (e.g., using reception component 1202) may receive the second report, as described above in connection with, for example, FIG. 4 and at 430. In some aspects, the second report may include some or all of the information as described above at 730 with respect to the first report.

At 790, the base station may transmit, to the UE and based at least in part on the second report, an indication of a second mapping between the second reference signal and one of the second plurality of antenna panels. For example, the base station (e.g., using transmission component 1204) may transmit the second mapping, as described above in connection with, for example, FIG. 4. In some aspects, the second mapping is included in an RRC message, a control element, or DCI. In some aspects, the second mapping is applied a period of time after receiving the indication of the second mapping.

At 795, the base station may receive, from the UE, an acknowledgement based at least in part on receiving the indication of the second mapping. For example, the base station (e.g., using reception component 1202) may receive the acknowledgement, as described above in connection with, for example, FIG. 4. In some aspects, the second mapping is applied a period of time after transmitting the acknowledgement.

Although FIG. 7 shows example blocks of method 700, in some aspects, method 700 may include additional blocks, fewer blocks, different blocks, or differently arranged blocks than those depicted in FIG. 7. Additionally, or alternatively, two or more of the blocks of method 700 may be performed in parallel.

FIG. 8 is a flowchart of an example method 800 of wireless communication. The method 800 may be performed by, for example, a UE (e.g., UE 120 of FIG. 1 and/or apparatus 1000 of FIG. 10).

At 810, in some aspects, the UE may receive, from a base station (e.g., base station 110 of FIG. 1 and/or apparatus 1200 of FIG. 12), a configuration associated with a first plurality of reference signals. For example, the UE (e.g., using reception component 1002, depicted in FIG. 10) may receive the configuration, as described above in connection with, for example, FIG. 5 and at 505. In some aspects, the configuration includes an indication of a first antenna panel associated with the UE. Additionally, or alternatively, the configuration includes an instruction to include an identifier selected from the space of uplink identifiers. Additionally, or alternatively, the configuration includes an indication of a quantity of the first plurality of reference signals. The indication may be based at least in part on a capability associated with the UE. Additionally, or alternatively, the configuration includes an indication of a maximum quantity of reference signals, such that a quantity of the first plurality of reference signals is less than or equal to the maximum quantity. The indication may be based at least in part on a capability associated with the UE.

At 820, the UE may measure, using the first antenna panel associated with the UE, the first plurality of reference signals from the base station. For example, the UE (e.g., using measurement component 1008, depicted in FIG. 10) may measure the first plurality of reference signals, as described above in connection with, for example, FIG. 5 and at 510. In some aspects, measuring the first plurality of reference signals comprises determining at least one of an RSRP, an SINR, a CQI, an RI, a PMI, an interference estimate, a pathloss estimate, a power headroom for uplink, a power backoff for uplink, an estimated RSRP for uplink, or a combination thereof.

At 830, the UE may transmit, to the base station, a first report, based at least in part on measuring the first plurality of reference signals, that is associated with a corresponding identifier for the first antenna panel. For example, the UE (e.g., using transmission component 1004, depicted in FIG. 10) may transmit the first report, as described above in connection with, for example, FIG. 5 and at 515. In some aspects, the first report is included in UCI or a control element. In some aspects, the first report further includes the corresponding identifier for the first antenna panel. In some aspects, the corresponding identifier is selected from a space of downlink identifiers. Additionally, in some aspects, the first report further includes an identifier, corresponding to the first antenna panel, selected from a space of uplink identifiers. In such aspects, the first report may further include bits indicating that the identifier, selected from the space of uplink identifiers, is included in the first report. As an alternative, the corresponding identifier is selected from a space of joint downlink-uplink identifiers.

In some aspects, the first report includes a plurality of absolute measurement values. As an alternative, the first report includes at least one absolute measurement value and at least one relative measurement value. As an alternative, the first report includes a plurality of relative measurement values.

At 840, the UE may receive, from the base station and based at least in part on the first report, an indication of a first mapping between the first antenna panel and one of the first plurality of reference signals. For example, the UE (e.g., using reception component 1002) may receive the first mapping, as described above in connection with, for example, FIG. 4. In some aspects, the first mapping is included in an RRC message, a control element, or DCI. In some aspects, the first mapping is applied a period of time after receiving the indication of the first mapping.

At 850, the UE may transmit, to the base station, an acknowledgement based at least in part on receiving the indication of the first mapping. For example, the UE (e.g., using transmission component 1004) may transmit the acknowledgement, as described above in connection with, for example, FIG. 4. In some aspects, the first mapping is applied a period of time after transmitting the acknowledgement.

At 860, in some aspects, the UE may receive, from the base station, a configuration associated with a second plurality of reference signals. For example, the UE (e.g., using reception component 1002) may receive the configuration, as described above in connection with, for example, FIG. 5 and at 520. In some aspects, the configuration includes an indication of a second antenna panel associated with the UE. Additionally, or alternatively, the configuration may include some or all of the indications as described above at 810 with respect to the configuration associated with the first plurality of reference signals. The configuration associated with the second plurality of reference signals may be included with the configuration associated with the first plurality of reference signals or in a separate message.

At 870, the UE may measure, using the second antenna panel associated with the UE, the second plurality of reference signals from the base station. For example, the UE (e.g., using measurement component 1008) may measure the second plurality of reference signals, as described above in connection with, for example, FIG. 5 and at 525. In some aspects, measuring the second plurality of reference signals comprises determining at least one of an RSRP, an SINR, a CQI, an RI, a PMI, an interference estimate, a pathloss estimate, a power headroom for uplink, a power backoff for uplink, an estimated RSRP for uplink, or a combination thereof.

At 880, the UE may transmit, to the base station, a second report, based at least in part on measuring the second plurality of reference signals, that is associated with a corresponding identifier for the second antenna panel. For example, the UE (e.g., using transmission component 1004) may transmit the second report, as described above in connection with, for example, FIG. 5 and at 530. In some aspects, the second report is included in UCI or a control element. In some aspects, the second report further includes the corresponding identifier for the second antenna panel. In some aspects, the second report may include some or all of the information as described above at 830 with respect to the first report.

At 890, the UE may receive, from the base station and based at least in part on the second report, an indication of a second mapping between the second antenna panel and one of the second plurality of reference signals. For example, the UE (e.g., using reception component 1002) may receive the second mapping, as described above in connection with, for example, FIG. 4. In some aspects, the second mapping is included in an RRC message, a control element, or DCI. In some aspects, the second mapping is applied a period of time after receiving the indication of the second mapping.

At 895, the UE may transmit, to the base station, an acknowledgement based at least in part on receiving the indication of the second mapping. For example, the UE (e.g., using transmission component 1004) may transmit the acknowledgement, as described above in connection with, for example, FIG. 4. In some aspects, the second mapping is applied a period of time after transmitting the acknowledgement.

Although FIG. 8 shows example blocks of method 800, in some aspects, method 800 may include additional blocks, fewer blocks, different blocks, or differently arranged blocks than those depicted in FIG. 8. Additionally, or alternatively, two or more of the blocks of method 800 may be performed in parallel.

FIG. 9 is a flowchart of an example method 900 of wireless communication. The method 900 may be performed by, for example, a base station (e.g., base station 110 of FIG. 1 and/or apparatus 1200 of FIG. 12).

At 910, the base station may transmit, to a UE (e.g., UE 120 of FIG. 1 and/or apparatus 1000 of FIG. 10), a configuration associated with a first plurality of reference signals. For example, the base station (e.g., using transmission component 1204, depicted in FIG. 12) may transmit the configuration, as described above in connection with, for example, FIG. 5 and at 505. In some aspects, the configuration includes an indication of a first antenna panel associated with the UE. Additionally, or alternatively, the configuration includes an instruction to include an identifier selected from the space of uplink identifiers. Additionally, or alternatively, the configuration includes an indication of a quantity of the first plurality of reference signals. The indication may be based at least in part on a capability associated with the UE. Additionally, or alternatively, the configuration includes an indication of a maximum quantity of reference signals, such that a quantity of the first plurality of reference signals is less than or equal to the maximum quantity. The indication may be based at least in part on a capability associated with the UE.

At 920, the base station may transmit, to the UE, the first plurality of reference signals. For example, the base station (e.g., using transmission component 1204) may transmit the first plurality of reference signals, as described above in connection with, for example, FIG. 5 and at 510. In some aspects, the first plurality of reference signals may include one or more SSBs, one or more TRSs, one or more CSI-RSs, and/or one or more other reference signals.

At 930, the base station may receive, from the UE, a first report, based at least in part on measurements of the first plurality of reference signals, that is associated with a corresponding identifier for the first antenna panel associated with the UE. For example, the base station (e.g., using reception component 1202, depicted in FIG. 12) may receive the first report, as described above in connection with, for example, FIG. 5 and at 515. In some aspects, the measurements of the first plurality of reference signals include at least one of an RSRP, an SINR, a CQI, an RI, a PMI, an interference estimate, a pathloss estimate, a power headroom for uplink, a power backoff for uplink, an estimated RSRP for uplink, or a combination thereof.

In some aspects, the first report is included in UCI or a control element. In some aspects, the first report further includes the corresponding identifier for the first antenna panel. In some aspects, the corresponding identifier is selected from a space of downlink identifiers. Additionally, in some aspects, the first report further includes an identifier, corresponding to the first antenna panel, selected from a space of uplink identifiers. In such aspects, the first report may further include bits indicating that the identifier, selected from the space of uplink identifiers, is included in the first report. As an alternative, the corresponding identifier is selected from a space of joint downlink-uplink identifiers.

In some aspects, the first report includes a plurality of absolute measurement values. As an alternative, the first report includes at least one absolute measurement value and at least one relative measurement value. As an alternative, the first report includes a plurality of relative measurement values.

At 940, the base station may transmit, to the UE and based at least in part on the first report, an indication of a first mapping between the first antenna panel and one of the first plurality of reference signals. For example, the base station (e.g., using transmission component 1204) may transmit the first mapping, as described above in connection with, for example, FIG. 5. In some aspects, the first mapping is included in an RRC message, a control element, or DCI. In some aspects, the first mapping is applied a period of time after receiving the indication of the first mapping.

At 950, the base station may receive, from the UE, an acknowledgement based at least in part on receiving the indication of the first mapping. For example, the base station (e.g., using reception component 1202) may receive the acknowledgement, as described above in connection with, for example, FIG. 5. In some aspects, the first mapping is applied a period of time after transmitting the acknowledgement.

At 960, in some aspects, the base station may transmit, to the UE, a configuration associated with a second plurality of reference signals. For example, the base station (e.g., using transmission component 1204) may transmit the configuration, as described above in connection with, for example, FIG. 5 and at 520. In some aspects, the configuration may include some or all of the indications as described above at 910 with respect to the configuration associated with the first plurality of reference signals. The configuration associated with the second plurality of reference signals may be included with the configuration associated with the first plurality of reference signals or in a separate message.

At 970, the base station may transmit, to the UE, the second plurality of reference signals. For example, the base station (e.g., using transmission component 1204) may transmit the second plurality of reference signals, as described above in connection with, for example, FIG. 5 and at 525. In some aspects, the second plurality of reference signals may include one or more SSBs, one or more TRSs, one or more CSI-RSs, and/or one or more other reference signals.

At 980, the base station may receive, from the UE, a second report, based at least in part on measuring the second plurality of reference signals, that is associated with a corresponding identifier for a second antenna panel associated with the UE. For example, the base station (e.g., using reception component 1202) may receive the second report, as described above in connection with, for example, FIG. 5 and at 530. In some aspects, the second report is included in UCI or a control element. In some aspects, the second report further includes the corresponding identifier for the second antenna panel. In some aspects, the second report may include some or all of the information as described above at 930 with respect to the first report.

At 990, the base station may transmit, to the UE and based at least in part on the second report, an indication of a second mapping between the second antenna panel and one of the second plurality of reference signals. For example, the base station (e.g., using transmission component 1204) may transmit the second mapping, as described above in connection with, for example, FIG. 5. In some aspects, the second mapping is included in an RRC message, a control element, or DCI. In some aspects, the second mapping is applied a period of time after receiving the indication of the second mapping.

At 995, the base station may receive, from the UE, an acknowledgement based at least in part on receiving the indication of the second mapping. For example, the base station (e.g., using reception component 1202) may receive the acknowledgement, as described above in connection with, for example, FIG. 5. In some aspects, the second mapping is applied a period of time after transmitting the acknowledgement.

Although FIG. 9 shows example blocks of method 900, in some aspects, method 900 may include additional blocks, fewer blocks, different blocks, or differently arranged blocks than those depicted in FIG. 9. Additionally, or alternatively, two or more of the blocks of method 900 may be performed in parallel.

FIG. 10 is a block diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a measurement component 1008, among other examples.

In some aspects, the apparatus 1000 may be configured to perform one or more operations described herein in connection with FIGS. 4-5. Additionally, or alternatively, the apparatus 1000 may be configured to perform one or more processes described herein, such as method 600 of FIG. 6, method 800 of FIG. 8, or a combination thereof. In some aspects, the apparatus 1000 and/or one or more components shown in FIG. 10 may include one or more components of the UE described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described above in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described above in connection with FIG. 2. In some aspects, the transmission component 1004 may be co-located with the reception component 1002 in a transceiver.

In some aspects, the measurement component 1008 may measure, using a first plurality of antenna panels, a first reference signal from the apparatus 1006. In some aspects, the measurement component 1008 may include one or more antennas, a modem, a demodulator, a MIMO detector, a receive processor, a controller/processor, a memory, or a combination thereof, of the UE described above in connection with FIG. 2. Additionally, the transmission component 1004 may transmit, to the apparatus 1006, a first report based at least in part on measuring the first reference signal, where the first report includes corresponding identifiers for each antenna from the first plurality of antenna panels.

In some aspects, the measurement component 1008 may further measure, using a second plurality of antenna panels, a second reference signal from the apparatus 1006. Accordingly, the transmission component 1004 may transmit, to the apparatus 1006, a second report based at least in part on measuring the second reference signal, where the second report includes corresponding identifiers for each antenna from the second plurality of antenna panels.

In some aspects, the reception component 1002 may receive, from the apparatus 1006, an instruction to include one or more identifiers selected from the space of uplink identifiers. Additionally, or alternatively, the reception component 1002 may receive, from the apparatus 1006, an indication of a quantity of antenna panels in the first plurality of antenna panels. Additionally, or alternatively, the reception component 1002 may receive, from the apparatus 1006, an indication of a maximum quantity of antenna panels, where a quantity of antenna panels in the first plurality of antenna panels is less than or equal to the maximum quantity. Additionally, or alternatively, the reception component 1002 may receive, from the apparatus 1006, an indication of a measurement threshold, where all measurements in the first report satisfy the measurement threshold.

In some aspects, the reception component 1002 may receive, from the apparatus 1006 and based at least in part on the first report, an indication of a first mapping between the first reference signal and one of the first plurality of antenna panels. In some aspects, the transmission component 1004 may further transmit, to the apparatus 1006, an acknowledgement based at least in part on receiving the indication of the first mapping.

In some aspects, the measurement component 1008 may measure, using a first antenna panel, a first plurality of reference signals from the apparatus 1006. Additionally, the transmission component 1004 may transmit, to the apparatus 1006, a first report based at least in part on measuring the first plurality of reference signals, where the first report is associated with a corresponding identifier for the first antenna panel.

In some aspects, the measurement component 1008 may further measure, using a second antenna panel, a second plurality of reference signals from the apparatus 1006. Accordingly, the transmission component 1004 may transmit, to the apparatus 1006, a second report based at least in part on measuring the second plurality of reference signals, where the second report is associated with a corresponding identifier for the second antenna panel.

In some aspects, the reception component 1002 may receive, from the apparatus 1006, an indication of the first antenna panel. Additionally, or alternatively, the reception component 1002 may receive, from the apparatus 1006, an instruction to include an identifier selected from the space of uplink identifiers. Additionally, or alternatively, the reception component 1002 may receive, from the apparatus 1006, an indication of a quantity of the first plurality of reference signals. Additionally, or alternatively, the reception component 1002 may receive, from the apparatus 1006, an indication of a maximum quantity of reference signals, where a quantity of the first plurality of reference signals is less than or equal to the maximum quantity.

In some aspects, the reception component 1002 may receive, from the apparatus 1006 and based at least in part on the first report, an indication of a first mapping between one of the first plurality of reference signals and the first antenna panel. In some aspects, the transmission component 1004 may further transmit, to the apparatus 1006, an acknowledgement based at least in part on receiving the indication of the first mapping.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

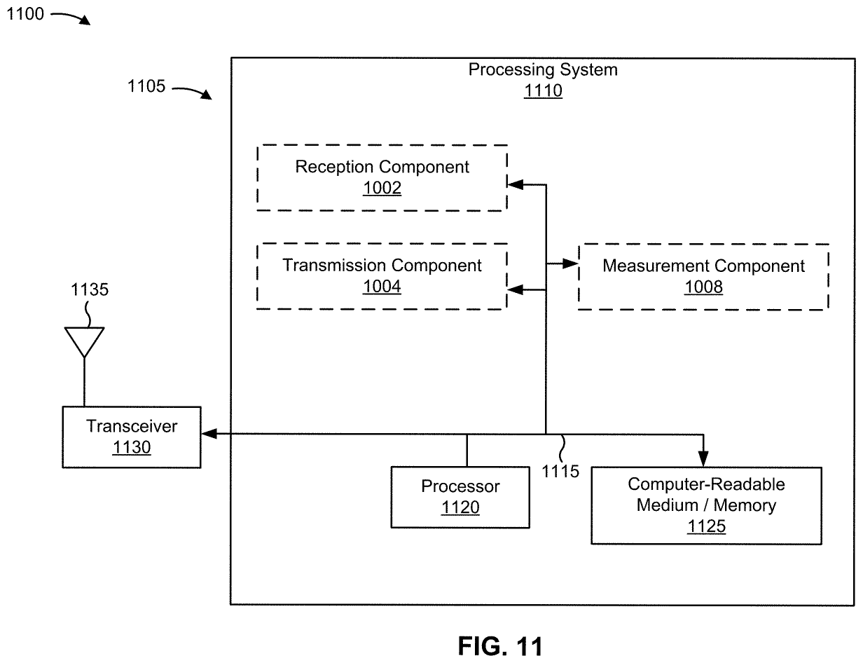

FIG. 11 is a diagram illustrating an example 1100 of a hardware implementation for an apparatus 1105 employing a processing system 1110. The apparatus 1105 may be a UE.

The processing system 1110 may be implemented with a bus architecture, represented generally by the bus 1115. The bus 1115 may include any number of interconnecting buses and bridges depending on the specific application of the processing system 1110 and the overall design constraints. The bus 1115 links together various circuits including one or more processors and/or hardware components, represented by the processor 1120, the illustrated components, and the computer-readable medium/memory 1125. The bus 1115 may also link various other circuits, such as timing sources, peripherals, voltage regulators, power management circuits, and/or the like.

The processing system 1110 may be coupled to a transceiver 1130. The transceiver 1130 is coupled to one or more antennas 1135. The transceiver 1130 provides a means for communicating with various other apparatuses over a transmission medium. The transceiver 1130 receives a signal from the one or more antennas 1135, extracts information from the received signal, and provides the extracted information to the processing system 1110, specifically the reception component 1002. In addition, the transceiver 1130 receives information from the processing system 1110, specifically the transmission component 1004, and generates a signal to be applied to the one or more antennas 1135 based at least in part on the received information.

The processing system 1110 includes a processor 1120 coupled to a computer-readable medium/memory 1125. The processor 1120 is responsible for general processing, including the execution of software stored on the computer-readable medium/memory 1125. The software, when executed by the processor 1120, causes the processing system 1110 to perform the various functions described herein for any particular apparatus. The computer-readable medium/memory 1125 may also be used for storing data that is manipulated by the processor 1120 when executing software. The processing system further includes at least one of the illustrated components. The components may be software modules running in the processor 1120, resident/stored in the computer-readable medium/memory 1125, one or more hardware modules coupled to the processor 1120, or some combination thereof.

In some aspects, the processing system 1110 may be a component of the UE 120 and may include the memory 282 and/or at least one of the TX MIMO processor 266, the RX processor 258, and/or the controller/processor 280. In some aspects, the apparatus 1105 for wireless communication includes means for measuring, using a first plurality of antenna panels associated with the UE, a first reference signal from a base station; means for transmitting, to the base station, a first report based at least in part on measuring the first reference signal, wherein the first report includes corresponding identifiers for each antenna from the first plurality of antenna panels; means for measuring, using a second plurality of antenna panels associated with the UE, a second reference signal from the base station; means for transmitting, to the base station, a second report based at least in part on measuring the second reference signal, wherein the second report includes corresponding identifiers for each antenna from the second plurality of antenna panels; means for receiving, from the base station, an instruction to include one or more identifiers selected from the space of uplink identifiers; means for receiving, from the base station, an indication of a quantity of antenna panels in the first plurality of antenna panels associated with the UE; means for receiving, from the base station, an indication of a maximum quantity of antenna panels, wherein a quantity of antenna panels in the first plurality of antenna panels associated with the UE is less than or equal to the maximum quantity; means for receiving, from the base station, an indication of a measurement threshold, wherein all measurements in the first report satisfy the measurement threshold; means for receiving, from the base station and based at least in part on the first report, an indication of a first mapping between the first reference signal and one of the first plurality of antenna panels; and/or means for transmitting, to the base station, an acknowledgement based at least in part on receiving the indication of the first mapping, wherein the first mapping is applied a period of time after transmitting the acknowledgement. The aforementioned means may be one or more of the aforementioned components of the apparatus 1000 and/or the processing system 1110 of the apparatus 1105 configured to perform the functions recited by the aforementioned means. As described elsewhere herein, the processing system 1110 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

In some aspects, the processing system 1110 may be a component of the UE 120 and may include the memory 282 and/or at least one of the TX MIMO processor 266, the RX processor 258, and/or the controller/processor 280. In some aspects, the apparatus 1105 for wireless communication includes means for measuring, using a first antenna panel associated with the UE, a first plurality of reference signals from a base station; means for transmitting, to the base station, a first report based at least in part on measuring the first plurality of reference signals, wherein the first report is associated with a corresponding identifier for the first antenna panel; means for measuring, using a second antenna panel associated with the UE, a second plurality of reference signals from the base station; means for transmitting, to the base station, a second report based at least in part on measuring the second plurality of reference signals, wherein the second report is associated with a corresponding identifier for the second antenna panel; means for receiving, from the base station, an indication of the first antenna panel; means for receiving, from the base station, an instruction to include an identifier selected from the space of uplink identifiers; means for receiving, from the base station, an indication of a quantity of the first plurality of reference signals; means for receiving, from the base station, an indication of a maximum quantity of reference signals, wherein a quantity of the first plurality of reference signals is less than or equal to the maximum quantity; means for receiving, from the base station and based at least in part on the first report, an indication of a first mapping between one of the first plurality of reference signals and the first antenna panel; and/or means for transmitting, to the base station, an acknowledgement based at least in part on receiving the indication of the first mapping, wherein the first mapping is applied a period of time after transmitting the acknowledgement. The aforementioned means may be one or more of the aforementioned components of the apparatus 1000 and/or the processing system 1110 of the apparatus 1105 configured to perform the functions recited by the aforementioned means. As described elsewhere herein, the processing system 1110 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 11 is provided as an example. Other examples may differ from what is described in connection with FIG. 11.

FIG. 12 is a block diagram of an example apparatus 1200 for wireless communication. The apparatus 1200 may be a base station, or a base station may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a determination component 1208, among other examples.

In some aspects, the apparatus 1200 may be configured to perform one or more operations described herein in connection with FIGS. 4-5. Additionally, or alternatively, the apparatus 1200 may be configured to perform one or more processes described herein, such as method 700 of FIG. 7, method 900 of FIG. 9, or a combination thereof. In some aspects, the apparatus 1200 and/or one or more components shown in FIG. 12 may include one or more components of the base station described above in connection with FIG. 2. Additionally, or alternatively, one or more components shown in FIG. 12 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the base station described above in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the base station described above in connection with FIG. 2. In some aspects, the transmission component 1204 may be co-located with the reception component 1202 in a transceiver.

In some aspects, the transmission component 1204 may transmit, to the apparatus 1206, a first reference signal. Additionally, the reception component 1202 may receive, from the apparatus 1206, a first report based at least in part on one or more measurements of the first reference signal, where the first report includes corresponding identifiers for each antenna from a first plurality of antenna panels associated with the apparatus 1206.

In some aspects, the transmission component 1204 may further transmit, to the apparatus 1206, a second reference signal. Accordingly, the reception component 1202 may receive, from the apparatus 1206, a second report based at least in part on one or more measurements of the second reference signal, where the second report includes corresponding identifiers for each antenna from a second plurality of antenna panels associated with the apparatus 1206.

In some aspects, the transmission component 1204 may transmit, to the apparatus 1206, an instruction to include one or more identifiers selected from the space of uplink identifiers. Additionally, or alternatively, the transmission component 1204 may transmit, to the apparatus 1206, an indication of a quantity of antenna panels in the first plurality of antenna panels associated with the apparatus 1206. Additionally, or alternatively, the transmission component 1204 may transmit, to the apparatus 1206, an indication of a maximum quantity of antenna panels, where a quantity of antenna panels in the first plurality of antenna panels associated with the apparatus 1206 is less than or equal to the maximum quantity. Additionally, or alternatively, the transmission component 1204 may transmit, to the apparatus 1206, an indication of a measurement threshold, where all measurements in the first report satisfy the measurement threshold.

In some aspects, the transmission component 1204 may further transmit, to the apparatus 1206 and based at least in part on the first report, an indication of a first mapping between the first reference signal and one of the first plurality of antenna panels. For example, the determination component 1208 may determine the first mapping based at least in part on the first report. In some aspects, the determination component 1208 may include a receive processor, a transmit MIMO processor, a transmit processor, a controller/processor, a memory, or a combination thereof, of the base station described above in connection with FIG. 2. Additionally, in some aspects, the reception component 1202 may receive, from the apparatus 1206, an acknowledgement based at least in part on receiving the indication of the first mapping.

In some aspects, the transmission component 1204 may transmit, to the apparatus 1206, a first plurality of reference signals. Additionally, the reception component 1202 may receive, from the apparatus 1206, a first report based at least in part on measurements of the first plurality of reference signals, where the first report is associated with a corresponding identifier for a first antenna panel associated with the apparatus 1206.

In some aspects, the transmission component 1204 may further transmit, to the apparatus 1206, a second plurality of reference signals. Accordingly, the reception component 1202 may receive, from the apparatus 1206, a second report based at least in part on measurements of the second plurality of reference signals, where the second report is associated with a corresponding identifier for a second antenna panel associated with the apparatus 1206.

In some aspects, the transmission component 1204 may transmit, to the apparatus 1206, an indication of the first antenna panel. Additionally, or alternatively, the transmission component 1204 may transmit, to the apparatus 1206, an instruction to include an identifier selected from the space of uplink identifiers. Additionally, or alternatively, the transmission component 1204 may transmit, to the apparatus 1206, an indication of a quantity of the first plurality of reference signals. Additionally, or alternatively, the transmission component 1204 may transmit, to the apparatus 1206, an indication of a maximum quantity of reference signals, where a quantity of the first plurality of reference signals is less than or equal to the maximum quantity.

In some aspects, the transmission component 1204 may further transmit, to the apparatus 1206 and based at least in part on the first report, an indication of a first mapping between one of the first plurality of reference signals and the first antenna panel. For example, the determination component 1208 may determine the first mapping based at least in part on the first report. Additionally, in some aspects, the reception component 1202 may receive, from the apparatus 1206, an acknowledgement based at least in part on receiving the indication of the first mapping.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

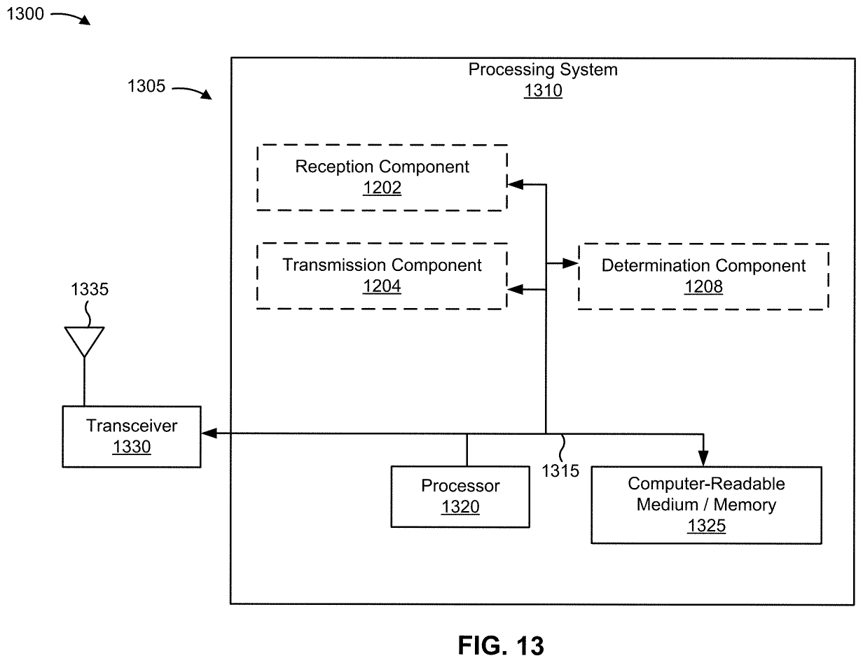

FIG. 13 is a diagram illustrating an example 1300 of a hardware implementation for an apparatus 1305 employing a processing system 1310. The apparatus 1305 may be a base station.

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors and/or hardware components, represented by the processor 1320, the illustrated components, and the computer-readable medium/memory 1325. The bus 1315 may also link various other circuits, such as timing sources, peripherals, voltage regulators, power management circuits, and/or the like.

The processing system 1310 may be coupled to a transceiver 1330. The transceiver 1330 is coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1202. In addition, the transceiver 1330 receives information from the processing system 1310, specifically the transmission component 1204, and generates a signal to be applied to the one or more antennas 1335 based at least in part on the received information.

The processing system 1310 includes a processor 1320 coupled to a computer-readable medium/memory 1325. The processor 1320 is responsible for general processing, including the execution of software stored on the computer-readable medium/memory 1325. The software, when executed by the processor 1320, causes the processing system 1310 to perform the various functions described herein for any particular apparatus. The computer-readable medium/memory 1325 may also be used for storing data that is manipulated by the processor 1320 when executing software. The processing system further includes at least one of the illustrated components. The components may be software modules running in the processor 1320, resident/stored in the computer-readable medium/memory 1325, one or more hardware modules coupled to the processor 1320, or some combination thereof.

In some aspects, the processing system 1310 may be a component of the base station 110 and may include the memory 242 and/or at least one of the TX MIMO processor 230, the RX processor 238, and/or the controller/processor 240. In some aspects, the apparatus 1305 for wireless communication includes means for transmitting, to a UE, a first reference signal; means for receiving, from the UE, a first report based at least in part on one or more measurements of the first reference signal, wherein the first report includes corresponding identifiers for each antenna from a first plurality of antenna panels associated with the UE; means for transmitting, to the UE, a second reference signal; means for receiving, from the UE, a second report based at least in part on one or more measurements of the second reference signal, wherein the second report includes corresponding identifiers for each antenna from a second plurality of antenna panels associated with the UE; means for transmitting, to the UE, an instruction to include one or more identifiers selected from the space of uplink identifiers; means for transmitting, to the UE, an indication of a quantity of antenna panels in the first plurality of antenna panels associated with the UE; means for transmitting, to the UE, an indication of a maximum quantity of antenna panels, wherein a quantity of antenna panels in the first plurality of antenna panels associated with the UE is less than or equal to the maximum quantity; means for transmitting, to the UE, an indication of a measurement threshold, wherein all measurements in the first report satisfy the measurement threshold; means for transmitting, to the UE and based at least in part on the first report, an indication of a first mapping between the first reference signal and one of the first plurality of antenna panels; and/or means for receiving, from the UE, an acknowledgement based at least in part on receiving the indication of the first mapping, wherein the first mapping is applied a period of time after receiving the acknowledgement. The aforementioned means may be one or more of the aforementioned components of the apparatus 1200 and/or the processing system 1310 of the apparatus 1305 configured to perform the functions recited by the aforementioned means. As described elsewhere herein, the processing system 1310 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

In some aspects, the processing system 1310 may be a component of the base station 110 and may include the memory 242 and/or at least one of the TX MIMO processor 230, the RX processor 238, and/or the controller/processor 240. In some aspects, the apparatus 1305 for wireless communication includes means for transmitting, to a UE, a first plurality of reference signals; means for receiving, from the UE, a first report based at least in part on measurements of the first plurality of reference signals, wherein the first report is associated with a corresponding identifier for a first antenna panel associated with the UE; means for transmitting, to the UE, a second plurality of reference signals; means for receiving, from the UE, a second report based at least in part on measurements of the second plurality of reference signals, wherein the second report is associated with a corresponding identifier for a second antenna panel associated with the UE; means for transmitting, to the UE, an indication of the first antenna panel; means for transmitting, to the UE, an instruction to include an identifier selected from the space of uplink identifiers; means for transmitting, to the UE, an indication of a quantity of the first plurality of reference signals; means for transmitting, to the UE, an indication of a maximum quantity of reference signals, wherein a quantity of the first plurality of reference signals is less than or equal to the maximum quantity; means for transmitting, to the UE and based at least in part on the first report, an indication of a first mapping between one of the first plurality of reference signals and the first antenna panel; and/or means for receiving, from the UE, an acknowledgement based at least in part on receiving the indication of the first mapping, wherein the first mapping is applied a period of time after receiving the acknowledgement. The aforementioned means may be one or more of the aforementioned components of the apparatus 1200 and/or the processing system 1310 of the apparatus 1305 configured to perform the functions recited by the aforementioned means. As described elsewhere herein, the processing system 1310 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 13 is provided as an example. Other examples may differ from what is described in connection with FIG. 13.

The following provides an overview of some Aspects of the present disclosure:

Aspect 1: A method of wireless communication performed by a user equipment (UE), comprising: measuring, using a first plurality of antenna panels associated with the UE, a first reference signal from a base station; and transmitting, to the base station, a first report based at least in part on measuring the first reference signal, wherein the first report includes corresponding identifiers for each antenna from the first plurality of antenna panels.

Aspect 2: The method of Aspect 1, further comprising: measuring, using a second plurality of antenna panels associated with the UE, a second reference signal from the base station; and transmitting, to the base station, a second report based at least in part on measuring the second reference signal, wherein the second report includes corresponding identifiers for each antenna from the second plurality of antenna panels.

Aspect 3: The method of any of Aspects 1 through 2, wherein measuring the first reference signal comprises determining at least one of: a reference signal received power (RSRP), a signal-to-interference-and-noise ratio (SINR), a channel quality indicator (CQI), a rank indicator (RI), a precoding matrix indicator (PMI), an interference estimate, a pathloss estimate, a power headroom for uplink, a power backoff for uplink, an estimated RSRP for uplink, or a combination thereof.

Aspect 4: The method of any of Aspects 1 through 3, wherein the corresponding identifiers are selected from a space of downlink identifiers.

Aspect 5: The method of Aspect 4, wherein the first report further includes one or more identifiers, corresponding to one or more of the first plurality of antenna panels, selected from a space of uplink identifiers.

Aspect 6: The method of Aspect 5, further comprising: receiving, from the base station, an instruction to include the one or more identifiers selected from the space of uplink identifiers.

Aspect 7: The method of any of Aspects 5 through 6, wherein the first report further includes bits indicating that the one or more identifiers, selected from the space of uplink identifiers, are included in the first report.

Aspect 8: The method of any of Aspects 1 through 3, wherein the corresponding identifiers are selected from a space of joint downlink-uplink identifiers.

Aspect 9: The method of any of Aspects 1 through 8, further comprising: receiving, from the base station, an indication of a quantity of antenna panels in the first plurality of antenna panels associated with the UE.

Aspect 10: The method of Aspect 9, wherein the indication is based at least in part on a capability associated with the UE.

Aspect 11: The method of any of Aspects 1 through 10, wherein the first report includes a predetermined value when a measurement associated with at least one antenna panel of the first plurality of antenna panels does not satisfy a measurement threshold.

Aspect 12: The method of any of Aspects 1 through 11, further comprising: receiving, from the base station, an indication of a maximum quantity of antenna panels, wherein a quantity of antenna panels in the first plurality of antenna panels associated with the UE is less than or equal to the maximum quantity.

Aspect 13: The method of Aspect 12, wherein the first report further includes bits indicating the quantity of the first plurality of antenna panels associated with the UE.

Aspect 14: The method of any of Aspects 12 through 13, wherein the indication is based at least in part on a capability associated with the UE.

Aspect 15: The method of any of Aspects 1 through 14, further comprising: receiving, from the base station, an indication of a measurement threshold, wherein all measurements in the first report satisfy the measurement threshold.

Aspect 16: The method of Aspect 15, wherein the measurement threshold includes an absolute value.

Aspect 17: The method of Aspect 15, wherein the measurement threshold includes a relative value.

Aspect 18: The method of any of Aspects 1 through 17, wherein the first report includes a plurality of absolute measurement values.

Aspect 19: The method of any of Aspects 1 through 17, wherein the first report includes at least one absolute measurement value and at least one relative measurement value.

Aspect 20: The method of any of Aspects 1 through 17, wherein the first report includes a plurality of relative measurement values.

Aspect 21: The method of any of Aspects 1 through 20, wherein the first report is included in uplink control information (UCI) or a control element.

Aspect 22: The method of any of Aspects 1 through 21, further comprising: receiving, from the base station and based at least in part on the first report, an indication of a first mapping between the first reference signal and one of the first plurality of antenna panels.

Aspect 23: The method of Aspect 22, wherein the first mapping is included in a radio resource control (RRC) message, a control element, or downlink control information (DCI).

Aspect 24: The method of any of Aspects 22 through 23, wherein the first mapping is applied a period of time after receiving the indication of the first mapping.

Aspect 25: The method of any of Aspects 22 through 24, further comprising: transmitting, to the base station, an acknowledgement based at least in part on receiving the indication of the first mapping, wherein the first mapping is applied a period of time after transmitting the acknowledgement.

Aspect 26: A method of wireless communication performed by a base station, comprising: transmitting, to a user equipment (UE), a first reference signal; and receiving, from the UE, a first report based at least in part on one or more measurements of the first reference signal, wherein the first report includes corresponding identifiers for each antenna from a first plurality of antenna panels associated with the UE.

Aspect 27: The method of Aspect 26, further comprising: transmitting, to the UE, a second reference signal; and receiving, from the UE, a second report based at least in part on one or more measurements of the second reference signal, wherein the second report includes corresponding identifiers for each antenna from a second plurality of antenna panels associated with the UE.

Aspect 28: The method of any of Aspects 26 through 27, wherein the one or more measurements of the first reference signal include at least one of: a reference signal received power (RSRP), a signal-to-interference-and-noise ratio (SINR), a channel quality indicator (CQI), a rank indicator (RI), a precoding matrix indicator (PMI), an interference estimate, a pathloss estimate, a power headroom for uplink, a power backoff for uplink, an estimated RSRP for uplink, or a combination thereof.

Aspect 29: The method of any of Aspects 26 through 28, wherein the corresponding identifiers are selected from a space of downlink identifiers.

Aspect 30: The method of Aspect 29, wherein the first report further includes one or more identifiers, corresponding to one or more of the first plurality of antenna panels, selected from a space of uplink identifiers.

Aspect 31: The method of Aspect 30, further comprising: transmitting, to the UE, an instruction to include the one or more identifiers selected from the space of uplink identifiers.

Aspect 32: The method of any of Aspects 30 through 31, wherein the first report further includes bits indicating that the one or more identifiers, selected from the space of uplink identifiers, are included in the first report.

Aspect 33: The method of any of Aspects 26 through 28, wherein the corresponding identifiers are selected from a space of joint downlink-uplink identifiers.

Aspect 34: The method of any of Aspects 26 through 33, further comprising: transmitting, to the UE, an indication of a quantity of antenna panels in the first plurality of antenna panels associated with the UE.

Aspect 35: The method of Aspect 34, wherein the indication is based at least in part on a capability associated with the UE.

Aspect 36: The method of any of Aspects 26 through 35, wherein the first report includes a predetermined value when a measurement associated with at least one antenna panel of the first plurality of antenna panels does not satisfy a measurement threshold.

Aspect 37: The method of any of Aspects 26 through 36, further comprising: transmitting, to the UE, an indication of a maximum quantity of antenna panels, wherein a quantity of antenna panels in the first plurality of antenna panels associated with the UE is less than or equal to the maximum quantity.

Aspect 38: The method of Aspect 37, wherein the first report further includes bits indicating the quantity of the first plurality of antenna panels associated with the UE.

Aspect 39: The method of any of Aspects 37 through 38, wherein the indication is based at least in part on a capability associated with the UE.

Aspect 40: The method of any of Aspects 26 through 39, further comprising: transmitting, to the UE, an indication of a measurement threshold, wherein all measurements in the first report satisfy the measurement threshold.

Aspect 41: The method of Aspect 40, wherein the measurement threshold includes an absolute value.

Aspect 42: The method of Aspect 40, wherein the measurement threshold includes a relative value.

Aspect 43: The method of any of Aspects 26 through 42, wherein the first report includes a plurality of absolute measurement values.

Aspect 44: The method of any of Aspects 26 through 42, wherein the first report includes at least one absolute measurement value and at least one relative measurement value.

Aspect 45: The method of any of Aspects 26 through 42, wherein the first report includes a plurality of relative measurement values.

Aspect 46: The method of any of Aspects 26 through 45, wherein the first report is included in uplink control information (UCI) or a control element.

Aspect 47: The method of any of Aspects 26 through 46, further comprising: transmitting, to the UE and based at least in part on the first report, an indication of a first mapping between the first reference signal and one of the first plurality of antenna panels.

Aspect 48: The method of Aspect 47, wherein the first mapping is included in a radio resource control (RRC) message, a control element, or downlink control information (DCI).

Aspect 49: The method of any of Aspects 47 through 48, wherein the first mapping is applied a period of time after transmitting the indication of the first mapping.

Aspect 50: The method of any of Aspects 47 through 49, further comprising: receiving, from the UE, an acknowledgement based at least in part on receiving the indication of the first mapping, wherein the first mapping is applied a period of time after receiving the acknowledgement.

Aspect 51: A method of wireless communication performed by a user equipment (UE), comprising: measuring, using a first antenna panel associated with the UE, a first plurality of reference signals from a base station; and transmitting, to the base station, a first report based at least in part on measuring the first plurality of reference signals, wherein the first report is associated with a corresponding identifier for the first antenna panel.

Aspect 52: The method of Aspect 51, further comprising: measuring, using a second antenna panel associated with the UE, a second plurality of reference signals from the base station; and transmitting, to the base station, a second report based at least in part on measuring the second plurality of reference signals, wherein the second report is associated with a corresponding identifier for the second antenna panel.

Aspect 53: The method of any of Aspects 51 through 52, wherein measuring the first plurality of reference signals comprises determining at least one of: a reference signal received power (RSRP), a signal-to-noise-and-interference ratio (SINR), a channel quality indicator (CQI), a rank indicator (RI), a precoding matrix indicator (PMI), an interference estimate, a pathloss estimate, a power headroom for uplink, a power backoff for uplink, an estimated RSRP for uplink, or a combination thereof.

Aspect 54: The method of any of Aspects 51 through 53, further comprising: receiving, from the base station, an indication of the first antenna panel.

Aspect 55: The method of any of Aspects 51 through 54, wherein the first report further includes the corresponding identifier for the first antenna panel.

Aspect 56: The method of Aspect 55, wherein the corresponding identifier is selected from a space of downlink identifiers.

Aspect 57: The method of Aspect 56, wherein the first report further includes an identifier, corresponding to the first antenna panel, selected from a space of uplink identifiers.

Aspect 58: The method of Aspect 57, further comprising: receiving, from the base station, an instruction to include the identifier selected from the space of uplink identifiers.

Aspect 59: The method of any of Aspects 57 through 58, wherein the first report further includes bits indicating that the identifier, selected from the space of uplink identifiers, is included in the first report.

Aspect 60: The method of Aspect 55, wherein the corresponding identifier is selected from a space of joint downlink-uplink identifiers.

Aspect 61: The method of any of Aspects 51 through 60, further comprising: receiving, from the base station, an indication of a quantity of the first plurality of reference signals.

Aspect 62: The method of Aspect 61, wherein the indication is based at least in part on a capability associated with the UE.

Aspect 63: The method of any of Aspects 51 through 62, further comprising: receiving, from the base station, an indication of a maximum quantity of reference signals, wherein a quantity of the first plurality of reference signals is less than or equal to the maximum quantity.

Aspect 64: The method of Aspect 63, wherein the indication is based at least in part on a capability associated with the UE.

Aspect 65: The method of any of Aspects 51 through 64, wherein the first report includes a plurality of absolute measurement values.

Aspect 66: The method of any of Aspects 51 through 64, wherein the first report includes at least one absolute measurement value and at least one relative measurement value.

Aspect 67: The method of any of Aspects 51 through 64, wherein the first report includes a plurality of relative measurement values.

Aspect 68: The method of any of Aspects 51 through 67, wherein the first report is included in uplink control information (UCI) or a control element.

Aspect 69: The method of any of Aspects 51 through 68, further comprising: receiving, from the base station and based at least in part on the first report, an indication of a first mapping between one of the first plurality of reference signals and the first antenna panel.

Aspect 70: The method of Aspect 69, wherein the first mapping is included in a radio resource control (RRC) message, a control element, or downlink control information (DCI).

Aspect 71: The method of any of Aspects 69 through 70, wherein the first mapping is applied a period of time after receiving the indication of the first mapping.

Aspect 72: The method of any of Aspects 69 through 71, further comprising: transmitting, to the base station, an acknowledgement based at least in part on receiving the indication of the first mapping, wherein the first mapping is applied a period of time after transmitting the acknowledgement.

Aspect 73: A method of wireless communication performed by a base station, comprising: transmitting, to a user equipment (UE), a first plurality of reference signals; and receiving, from the UE, a first report based at least in part on measurements of the first plurality of reference signals, wherein the first report is associated with a corresponding identifier for a first antenna panel associated with the UE.

Aspect 74: The method of Aspect 73, further comprising: transmitting, to the UE, a second plurality of reference signals; and receiving, from the UE, a second report based at least in part on measurements of the second plurality of reference signals, wherein the second report is associated with a corresponding identifier for a second antenna panel associated with the UE.

Aspect 75: The method of any of Aspects 73 through 74, wherein the measurements of the first plurality of reference signals include at least one of: a reference signal received power (RSRP), a signal-to-noise-and-interference ratio (SINR), a channel quality indicator (CQI), a rank indicator (RI), a precoding matrix indicator (PMI), an interference estimate, a pathloss estimate, a power headroom for uplink, a power backoff for uplink, an estimated RSRP for uplink, or a combination thereof.

Aspect 76: The method of any of Aspects 73 through 75, further comprising: transmitting, to the UE, an indication of the first antenna panel.

Aspect 77: The method of any of Aspects 73 through 76, wherein the first report further includes the corresponding identifier for the first antenna panel.

Aspect 78: The method of Aspect 77, wherein the corresponding identifier is selected from a space of downlink identifiers.

Aspect 79: The method of Aspect 78, wherein the first report further includes an identifier, corresponding to the first antenna panel, selected from a space of uplink identifiers.

Aspect 80: The method of Aspect 79, further comprising: transmitting, to the UE, an instruction to include the identifier selected from the space of uplink identifiers.

Aspect 81: The method of any of Aspects 79 through 80, wherein the first report further includes bits indicating that the identifier, selected from the space of uplink identifiers, is included in the first report.

Aspect 82: The method of Aspect 77, wherein the corresponding identifier is selected from a space of joint downlink-uplink identifiers.

Aspect 83: The method of any of Aspects 73 through 82, further comprising: transmitting, to the UE, an indication of a quantity of the first plurality of reference signals.

Aspect 84: The method of Aspect 83, wherein the indication is based at least in part on a capability associated with the UE.

Aspect 85: The method of any of Aspects 73 through 84, further comprising: transmitting, to the UE, an indication of a maximum quantity of reference signals, wherein a quantity of the first plurality of reference signals is less than or equal to the maximum quantity.

Aspect 86: The method of Aspect 85, wherein the indication is based at least in part on a capability associated with the UE.

Aspect 87: The method of any of Aspects 73 through 86, wherein the first report includes a plurality of absolute measurement values.

Aspect 88: The method of any of Aspects 73 through 86, wherein the first report includes at least one absolute measurement value and at least one relative measurement value.

Aspect 89: The method of any of Aspects 73 through 86, wherein the first report includes a plurality of relative measurement values.

Aspect 90: The method of any of Aspects 73 through 89, wherein the first report is included in uplink control information (UCI) or a control element.

Aspect 91: The method of any of Aspects 73 through 90, further comprising: transmitting, to the UE and based at least in part on the first report, an indication of a first mapping between one of the first plurality of reference signals and the first antenna panel.

Aspect 92: The method of Aspect 91, wherein the first mapping is included in a radio resource control (RRC) message, a control element, or downlink control information (DCI).

Aspect 93: The method of any of Aspects 91 through 92, wherein the first mapping is applied a period of time after receiving the indication of the first mapping.

Aspect 94: The method of any of Aspects 91 through 93, further comprising: receiving, from the UE, an acknowledgement based at least in part on receiving the indication of the first mapping, wherein the first mapping is applied a period of time after receiving the acknowledgement.

Aspect 95: An apparatus for wireless communication at a device, comprising a processor; memory coupled with the processor; and instructions stored in the memory and executable by the processor to cause the apparatus to perform the method of one or more of Aspects 1-25.

Aspect 96: A device for wireless communication, comprising a memory and one or more processors coupled to the memory, the one or more processors configured to perform the method of one or more of Aspects 1-25.

Aspect 97: An apparatus for wireless communication, comprising at least one means for performing the method of one or more of Aspects 1-25.

Aspect 98: A non-transitory computer-readable medium storing code for wireless communication, the code comprising instructions executable by a processor to perform the method of one or more of Aspects 1-25.

Aspect 99: A non-transitory computer-readable medium storing a set of instructions for wireless communication, the set of instructions comprising one or more instructions that, when executed by one or more processors of a device, cause the device to perform the method of one or more of Aspects 1-25.

Aspect 100: An apparatus for wireless communication at a device, comprising a processor; memory coupled with the processor; and instructions stored in the memory and executable by the processor to cause the apparatus to perform the method of one or more of Aspects 26-50.

Aspect 101: A device for wireless communication, comprising a memory and one or more processors coupled to the memory, the one or more processors configured to perform the method of one or more of Aspects 26-50.

Aspect 102: An apparatus for wireless communication, comprising at least one means for performing the method of one or more of Aspects 26-50.

Aspect 103: A non-transitory computer-readable medium storing code for wireless communication, the code comprising instructions executable by a processor to perform the method of one or more of Aspects 26-50.

Aspect 104: A non-transitory computer-readable medium storing a set of instructions for wireless communication, the set of instructions comprising one or more instructions that, when executed by one or more processors of a device, cause the device to perform the method of one or more of Aspects 26-50.

Aspect 105: An apparatus for wireless communication at a device, comprising a processor; memory coupled with the processor; and instructions stored in the memory and executable by the processor to cause the apparatus to perform the method of one or more of Aspects 51-72.

Aspect 106: A device for wireless communication, comprising a memory and one or more processors coupled to the memory, the one or more processors configured to perform the method of one or more of Aspects 51-72.

Aspect 107: An apparatus for wireless communication, comprising at least one means for performing the method of one or more of Aspects 51-72.

Aspect 108: A non-transitory computer-readable medium storing code for wireless communication, the code comprising instructions executable by a processor to perform the method of one or more of Aspects 51-72.

Aspect 109: A non-transitory computer-readable medium storing a set of instructions for wireless communication, the set of instructions comprising one or more instructions that, when executed by one or more processors of a device, cause the device to perform the method of one or more of Aspects 51-72.

Aspect 110: An apparatus for wireless communication at a device, comprising a processor; memory coupled with the processor; and instructions stored in the memory and executable by the processor to cause the apparatus to perform the method of one or more of Aspects 73-94.

Aspect 111: A device for wireless communication, comprising a memory and one or more processors coupled to the memory, the one or more processors configured to perform the method of one or more of Aspects 73-94.

Aspect 112: An apparatus for wireless communication, comprising at least one means for performing the method of one or more of Aspects 73-94.

Aspect 113: A non-transitory computer-readable medium storing code for wireless communication, the code comprising instructions executable by a processor to perform the method of one or more of Aspects 73-94.

Aspect 114: A non-transitory computer-readable medium storing a set of instructions for wireless communication, the set of instructions comprising one or more instructions that, when executed by one or more processors of a device, cause the device to perform the method of one or more of Aspects 73-94.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
measure, using a first plurality of antenna panels associated with the UE, a first reference signal from a base station; and
transmit, to the base station, a first report based at least in part on measuring the first reference signal, wherein the first report includes corresponding identifiers for each antenna from the first plurality of antenna panels.

2. The apparatus of claim 1, wherein the one or more processors are further configured to:
measure, using a second plurality of antenna panels associated with the UE, a second reference signal from the base station; and
transmit, to the base station, a second report based at least in part on measuring the second reference signal, wherein the second report includes corresponding identifiers for each antenna from the second plurality of antenna panels.

3. The apparatus of claim 1, wherein the corresponding identifiers are selected from a space of downlink identifiers.

4. The apparatus of claim 3, wherein the first report further includes one or more identifiers, corresponding to one or more of the first plurality of antenna panels, selected from a space of uplink identifiers.

5. The apparatus of claim 4, wherein the first report further includes bits indicating that the one or more identifiers, selected from the space of uplink identifiers, are included in the first report.

6. The apparatus of claim 1, wherein the corresponding identifiers are selected from a space of joint downlink-uplink identifiers.

7. The apparatus of claim 1, wherein the one or more processors are further configured to:
receive, from the base station, an indication of a quantity of antenna panels in the first plurality of antenna panels associated with the UE.

8. The apparatus of claim 1, wherein the first report includes a predetermined value when a measurement associated with at least one antenna panel of the first plurality of antenna panels does not satisfy a measurement threshold.

9. The apparatus of claim 1, wherein the one or more processors are further configured to:
receive, from the base station, an indication of a maximum quantity of antenna panels, wherein a quantity of antenna panels in the first plurality of antenna panels associated with the UE is less than or equal to the maximum quantity.

10. The apparatus of claim 9, wherein the first report further includes bits indicating the quantity of the first plurality of antenna panels associated with the UE.

11. The apparatus of claim 1, wherein the one or more processors are further configured to:
receive, from the base station, an indication of a measurement threshold, wherein all measurements in the first report satisfy the measurement threshold.

12. The apparatus of claim 1, wherein the one or more processors are further configured to:
receive, from the base station and based at least in part on the first report, an indication of a first mapping between the first reference signal and one of the first plurality of antenna panels.

13. The apparatus of claim 12, wherein the one or more processors are further configured to:
transmit, to the base station, an acknowledgement based at least in part on receiving the indication of the first mapping, wherein the first mapping is applied a period of time after transmitting the acknowledgement.

14. An apparatus for wireless communication at a base station, comprising:
a memory; and
one or more processors, coupled to the memory, configured to:
transmit, to a user equipment (UE), a first reference signal; and
receive, from the UE, a first report based at least in part on one or more measurements of the first reference signal, wherein the first report includes corresponding identifiers for each antenna from a first plurality of antenna panels associated with the UE.

15. The apparatus of claim 14, wherein the one or more processors are further configured to:
transmit, to the UE, a second reference signal; and
receive, from the UE, a second report based at least in part on one or more measurements of the second reference signal, wherein the second report includes corresponding identifiers for each antenna from a second plurality of antenna panels associated with the UE.

16. An apparatus for wireless communication at a user equipment (UE), comprising:
a memory; and
one or more processors, coupled to the memory, configured to:
measure, using a first antenna panel associated with the UE, a first plurality of reference signals from a base station; and
transmit, to the base station, a first report based at least in part on measuring the first plurality of reference signals, wherein the first report is associated with a corresponding identifier for the first antenna panel.

17. The apparatus of claim 16, wherein the one or more processors are further configured to:
measure, using a second antenna panel associated with the UE, a second plurality of reference signals from the base station; and
transmit, to the base station, a second report based at least in part on measuring the second plurality of reference signals, wherein the second report is associated with a corresponding identifier for the second antenna panel.

18. The apparatus of claim 16, wherein the one or more processors are further configured to:
receive, from the base station, an indication of the first antenna panel.

19. The apparatus of claim 16, wherein the first report further includes the corresponding identifier for the first antenna panel.

20. The apparatus of claim 19, wherein the corresponding identifier is selected from a space of downlink identifiers.

21. The apparatus of claim 20, wherein the first report further includes an identifier, corresponding to the first antenna panel, selected from a space of uplink identifiers.

22. The apparatus of claim 21, wherein the first report further includes bits indicating that the identifier, selected from the space of uplink identifiers, is included in the first report.

23. The apparatus of claim 19, wherein the corresponding identifier is selected from a space of joint downlink-uplink identifiers.

24. The apparatus of claim 16, wherein the one or more processors are further configured to:
receive, from the base station, an indication of a quantity of the first plurality of reference signals.

25. The apparatus of claim 16, wherein the one or more processors are further configured to:
receive, from the base station, an indication of a maximum quantity of reference signals, wherein a quantity of the first plurality of reference signals is less than or equal to the maximum quantity.

26. The apparatus of claim 16, wherein the one or more processors are further configured to:
receive, from the base station and based at least in part on the first report, an indication of a first mapping between one of the first plurality of reference signals and the first antenna panel.

27. The apparatus of claim 26, wherein the one or more processors are further configured to:
transmit, to the base station, an acknowledgement based at least in part on receiving the indication of the first mapping, wherein the first mapping is applied a period of time after transmitting the acknowledgement.

28. An apparatus for wireless communication at a base station, comprising:
a memory; and
one or more processors, coupled to the memory, configured to:
transmit, to a user equipment (UE), a first plurality of reference signals; and
receive, from the UE, a first report based at least in part on measurements of the first plurality of reference signals, wherein the first report is associated with a corresponding identifier for a first antenna panel associated with the UE.

29. The apparatus of claim 28, wherein the one or more processors are further configured to:
transmit, to the UE, a second plurality of reference signals; and
receive, from the UE, a second report based at least in part on measurements of the second plurality of reference signals, wherein the second report is associated with a corresponding identifier for a second antenna panel associated with the UE.

30. The apparatus of claim 28, wherein the one or more processors are further configured to:
transmit, to the UE and based at least in part on the first report, an indication of a first mapping between one of the first plurality of reference signals and the first antenna panel,
wherein the first mapping is applied a period of time after receiving the indication of the first mapping.
